(19) United States
(12) Patent Application Publication
(10) Pub. No.: US 2024/0284329 A1
(43) Pub. Date: Aug. 22, 2024

(54) WAKE-UP RADIO DESIRED CONFIGURATION BASED ON UE INDICATION

(71) Applicant: QUALCOMM Incorporated, San Diego, CA (US)

(72) Inventors: Ahmed Elshafie, San Diego, CA (US); Wanshi Chen, San Diego, CA (US); Huilin Xu, Temecula, CA (US); Diana Maamari, San Diego, CA (US); Wei Yang, San Diego, CA (US); Linhai He, San Diego, CA (US); Peter Gaal, San Diego, CA (US)

(21) Appl. No.: 18/170,334

(22) Filed: Feb. 16, 2023

(51) Int. Cl. H04W 52/02; H04W 76/28

(52) U.S. Cl. CPC H04W 52/0229; H04W 76/28

(57) ABSTRACT

Methods, systems, and devices for wireless communications are described. The described techniques provide for a network entity to indicate one or more wake-up radio (WUR) configurations to a user equipment (UE), which may communicate a desired WUR configuration with the network entity. The UE may indicate a request for the desired WUR configuration, may multiplex the request with another signal associated with the UE, or both. Additionally, or alternatively, the network entity may indicate a single WUR configuration to the UE, which may be determined according to desired configurations, a class of WUR, or both associated with a group of UEs including the UE. Such techniques may support a reduced overall power expenditure of the UE by improving WUR operation.

### FIELD OF TECHNOLOGY

The following relates to wireless communications, including wake-up radio desired configuration based on user equipment (UE) indication.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a UE may support communications using multiple radios. For example, the UE may perform communications using a main radio when operating in a high power state and may perform communications using a low power radio (e.g., a wake-up radio) when operating in a low power state. In some cases, the UE may receive a wake-up signal when operating in the low power state, which may trigger the UE to transition to the high power state for communicating subsequent messages.

### SUMMARY

The described techniques relate to improved methods, systems, devices, and apparatuses that support wake-up radio desired configuration based on user equipment (UE) indication. For example, the described techniques provide for a network entity indicating one or more wake-up radio (WUR) configurations to a UE, which may communicate a desired WUR configuration with the network entity. For example, the UE may indicate a request for the desired WUR configuration (e.g., via a dedicated signal), may multiplex the request with another signal associated with the UE (e.g., feedback messages, scheduling requests, UE reporting messages, or the like), or both. Additionally, or alternatively, the network entity may indicate a single WUR configuration to the UE, which may be determined according to desired configurations, a class of WUR, or both associated with a group of UEs (e.g., including the UE). Such techniques may support a reduced overall power expenditure of the UE by improving WUR operation.

A method for wireless communication at a UE is described. The method may include receiving, by a first radio of the UE that is operating in a first power state, control signaling indicating at least one configuration for a WUR of the UE for monitoring for wake-up signaling from a network entity, the first radio cycling between the first power state and a second power state that uses less power than the first power state, receiving, by the WUR of the UE when the first radio is operating in the second power state, a wake up signal in accordance with a first configuration of the at least one configuration, the wake up signal indicating to transition the first radio from the second power state to the first power state, and monitoring, by the first radio of the UE that is operating in the first power state, for a message in response to WUR of the UE receiving the wake up signal.

An apparatus for wireless communication at a UE is described. The apparatus may include a processor, memory coupled with the processor, and instructions stored in the memory. The instructions may be executable by the processor to cause the apparatus to receive, by a first radio of the UE that is operating in a first power state, control signaling indicating at least one configuration for a WUR of the UE for monitoring for wake-up signaling from a network entity, the first radio cycling between the first power state and a second power state that uses less power than the first power state, receive, by the WUR of the UE when the first radio is operating in the second power state, a wake up signal in accordance with a first configuration of the at least one configuration, the wake up signal indicating to transition the first radio from the second power state to the first power state, and monitor, by the first radio of the UE that is operating in the first power state, for a message in response to WUR of the UE receiving the wake up signal.

Another apparatus for wireless communication at a UE is described. The apparatus may include means for receiving, by a first radio of the UE that is operating in a first power state, control signaling indicating at least one configuration for a WUR of the UE for monitoring for wake-up signaling from a network entity, the first radio cycling between the first power state and a second power state that uses less power than the first power state, means for receiving, by the WUR of the UE when the first radio is operating in the second power state, a wake up signal in accordance with a first configuration of the at least one configuration, the wake up signal indicating to transition the first radio from the second power state to the first power state, and means for monitoring, by the first radio of the UE that is operating in the first power state, for a message in response to WUR of the UE receiving the wake up signal.

A non-transitory computer-readable medium storing code for wireless communication at a UE is described. The code may include instructions executable by a processor to receive, by a first radio of the UE that is operating in a first power state, control signaling indicating at least one configuration for a WUR of the UE for monitoring for wake-up signaling from a network entity, the first radio cycling between the first power state and a second power state that uses less power than the first power state, receive, by the WUR of the UE when the first radio is operating in the second power state, a wake up signal in accordance with a first configuration of the at least one configuration, the wake up signal indicating to transition the first radio from the second power state to the first power state, and monitor, by the first radio of the UE that is operating in the first power state, for a message in response to WUR of the UE receiving the wake up signal.

In some examples of the method, apparatuses, and non-transitory computer-readable medium described herein, communicating, with the network entity, a control message indicating at least the first configuration.

In some examples of the method, apparatuses, and non-transitory computer-readable medium described herein, communicating the control message may include operations, features, means, or instructions for transmitting, to the network entity, a request indicating at least the first configuration and receiving, from the network entity by the first radio that may be operating in the first power state, a response to the request, the response indicating approval to use at least the first configuration.

In some examples of the method, apparatuses, and non-transitory computer-readable medium described herein, the control signaling requests that the UE indicate one or more desired configurations for the WUR.

In some examples of the method, apparatuses, and non-transitory computer-readable medium described herein, a first configuration of the one or more desired configurations may be for operating the WUR in a radio resource control (RRC) idle state, a second configuration of the one or more desired configurations may be for operating the WUR in a RRC inactive state, a third configuration of the one or more desired configurations may be for operating the WUR in a RRC inactive state, or any combination thereof.

In some examples of the method, apparatuses, and non-transitory computer-readable medium described herein, communicating the control message may include operations, features, means, or instructions for transmitting a signal that multiplexes the control message with a first message associated with the UE.

In some examples of the method, apparatuses, and non-transitory computer-readable medium described herein, the first message includes a feedback message, a scheduling request, a buffer status report, a random access channel message, a channel state information message, RRC signaling, a medium access control control element, a UE assistance information message, a power headroom report, a small data transmission, or any combination thereof.

In some examples of the method, apparatuses, and non-transitory computer-readable medium described herein, communicating the control message may include operations, features, means, or instructions for communicating the control message via one or more time-frequency resources that may be scheduled for feedback.

Some examples of the method, apparatuses, and non-transitory computer-readable medium described herein may further include operations, features, means, or instructions for receiving, from the network entity via a physical downlink control channel, a physical downlink control channel skipping message scheduling transmission of the message via a physical downlink shared channel and indicating to skip monitoring of one or more control channel occasions, where the one or more time-frequency resources include a feedback resource for the physical downlink shared channel associated with the physical downlink control channel skipping message.

Some examples of the method, apparatuses, and non-transitory computer-readable medium described herein may further include operations, features, means, or instructions for receiving, from the network entity, an end of a burst indication associated with transmission of the control message via a physical downlink shared channel, where the one or more time-frequency resources include a feedback resource associated with the end of the burst indication.

In some examples of the method, apparatuses, and non-transitory computer-readable medium described herein, communicating the control message may include operations, features, means, or instructions for communicating the control message that may be a scheduling request, the scheduling request triggered in response to receiving the control signaling.

In some examples of the method, apparatuses, and non-transitory computer-readable medium described herein, the scheduling request includes a logical channel identifier or logical channel group identifier associated with the first configuration.

In some examples of the method, apparatuses, and non-transitory computer-readable medium described herein, communicating the control message may include operations, features, means, or instructions for receiving, from the network entity, an indication of one or more time-frequency resources that may be allocated for communicating the control message via a physical uplink control channel, where the indication may be received via a layer 1 message, a layer 2 message, a layer 3 message, a physical downlink control channel skipping message, a burst control signal, or any combination thereof.

In some examples of the method, apparatuses, and non-transitory computer-readable medium described herein, communicating the control message may include operations, features, means, or instructions for communicating the control message including an indication of one of a first time duration associated with the first radio transitioning from the second power state to the first power state after receiving the wake-up signal, or a second time duration associated with the first radio transitioning from the first power state to the second power state and the UE starting monitoring for the wake-up signaling by the WUR, or both.

In some examples of the method, apparatuses, and non-transitory computer-readable medium described herein, communicating the control message may include operations, features, means, or instructions for communicating the control message including an indication of a desired configuration of the at least one configuration or a type of the wake-up signaling.

In some examples of the method, apparatuses, and non-transitory computer-readable medium described herein, the first radio transitions to the second power state in response to communicating the control message.

In some examples of the method, apparatuses, and non-transitory computer-readable medium described herein, the wake up signal indicates the first configuration.

In some examples of the method, apparatuses, and non-transitory computer-readable medium described herein, the at least one configuration may be based on a preferred configuration of one or more other UEs, a class of the WUR, or both.

Some examples of the method, apparatuses, and non-transitory computer-readable medium described herein may further include operations, features, means, or instructions for transmitting, to the network entity by the first radio or by the WUR, an indication of a size of a guard band for the wake-up signal, where receiving the wake-up signal may be based on transmitting the indication.

In some examples of the method, apparatuses, and non-transitory computer-readable medium described herein, transmitting the indication may include operations, features, means, or instructions for transmitting the indication via one or more time-frequency resources that may be scheduled for uplink transmission, RRC signaling, a medium access control control element, a UE assistance information message, a feedback message, a scheduling request, a buffer status report, a random access channel message, or any combination thereof.

Some examples of the method, apparatuses, and non-transitory computer-readable medium described herein may further include operations, features, means, or instructions for receiving, from the network entity, an indication of a size of a guard band for the wake-up signal, the size of the guard band based on a class of the WUR, a preferred guard band size of one or more other UEs, or both, where receiving the wake-up signal may be based on receiving the indication.

In some examples of the method, apparatuses, and non-transitory computer-readable medium described herein, each configuration of the at least one configuration indicates a waveform of the wake-up signaling, a modulation and coding scheme of the wake-up signaling, a coding type of the wake-up signaling, a coding rate of the wake-up signaling, a periodicity of the wake-up signaling, a quantity of time-frequency resources associated with the wake-up signaling, a guard band associated with the wake-up signaling, a frequency band of the wake-up signaling, a frequency range of the wake-up signaling, one or more component carriers of the wake-up signaling, one or more bandwidth parts of the wake-up signaling, or any combination thereof.

In some examples of the method, apparatuses, and non-transitory computer-readable medium described herein, the WUR may be an ambient internet of things radio.

Some examples of the method, apparatuses, and non-transitory computer-readable medium described herein may further include operations, features, means, or instructions for operating the WUR according to a discontinuous reception cycle.

In some examples of the method, apparatuses, and non-transitory computer-readable medium described herein, monitoring for the message may include operations, features, means, or instructions for monitoring for the message during an active time of the discontinuous reception cycle.

In some examples of the method, apparatuses, and non-transitory computer-readable medium described herein, monitoring for the message may include operations, features, means, or instructions for monitoring one or more resource sets during an active time of the discontinuous reception cycle, each resource set of the one or more resource sets including at least one resource for receiving wake-up signaling.

In some examples of the method, apparatuses, and non-transitory computer-readable medium described herein, monitoring for the message may include operations, features, means, or instructions for monitoring for the message during an active time of a first discontinuous reception cycle, where the message includes a first type of message and monitoring for the message during an active time of a second discontinuous reception cycle, where the message includes a second type of message, where the first type of message includes a wake-up signal, control information, or both and the second type of message includes a reference signal, a synchronization signal, or both.

A method for wireless communication at a network entity is described. The method may include transmitting, to a first radio of a UE that is operating a first power state, control signaling indicating at least one configuration for a WUR of the UE for monitoring for wake-up signaling from the network entity, the first radio of the UE cycling between the first power state and a second power state that uses less power than the first power state, transmitting, to the WUR of the UE when the first radio of the UE is operating in the second power state, a wake up signal in accordance with a first configuration of the at least one configuration, the wake up signal indicating to transition the first radio from the second power state to the first power state, and communicating a message with the UE in response to transmitting the wake up signal in accordance with the first configuration.

An apparatus for wireless communication at a network entity is described. The apparatus may include a processor, memory coupled with the processor, and instructions stored in the memory. The instructions may be executable by the processor to cause the apparatus to transmit, to a first radio of a UE that is operating a first power state, control signaling indicating at least one configuration for a WUR of the UE for monitoring for wake-up signaling from the network entity, the first radio of the UE cycling between the first power state and a second power state that uses less power than the first power state, transmit, to the WUR of the UE when the first radio of the UE is operating in the second power state, a wake up signal in accordance with a first configuration of the at least one configuration, the wake up signal indicating to transition the first radio from the second power state to the first power state, and communicate a message with the UE in response to transmitting the wake up signal in accordance with the first configuration.

Another apparatus for wireless communication at a network entity is described. The apparatus may include means for transmitting, to a first radio of a UE that is operating a first power state, control signaling indicating at least one configuration for a WUR of the UE for monitoring for wake-up signaling from the network entity, the first radio of the UE cycling between the first power state and a second power state that uses less power than the first power state, means for transmitting, to the WUR of the UE when the first radio of the UE is operating in the second power state, a wake up signal in accordance with a first configuration of the at least one configuration, the wake up signal indicating to transition the first radio from the second power state to the first power state, and means for communicating a message with the UE in response to transmitting the wake up signal in accordance with the first configuration.

A non-transitory computer-readable medium storing code for wireless communication at a network entity is described. The code may include instructions executable by a processor to transmit, to a first radio of a UE that is operating a first power state, control signaling indicating at least one configuration for a WUR of the UE for monitoring for wake-up signaling from the network entity, the first radio of the UE cycling between the first power state and a second power state that uses less power than the first power state, transmit, to the WUR of the UE when the first radio of the UE is operating in the second power state, a wake up signal in accordance with a first configuration of the at least one configuration, the wake up signal indicating to transition the first radio from the second power state to the first power state, and communicate a message with the UE in response to transmitting the wake up signal in accordance with the first configuration.

In some examples of the method, apparatuses, and non-transitory computer-readable medium described herein, communicating, with the UE, a control message indicating at least the first configuration.

In some examples of the method, apparatuses, and non-transitory computer-readable medium described herein, communicating the control message may include operations, features, means, or instructions for receiving, from the UE, a request indicating at least the first configuration and transmitting, to the first radio of the UE that may be operating in the first power state, a response to the request, the response indicating approval to use at least the first configuration.

In some examples of the method, apparatuses, and non-transitory computer-readable medium described herein, the control signaling requests that the UE indicate one or more desired configurations for the WUR.

In some examples of the method, apparatuses, and non-transitory computer-readable medium described herein, communicating the control message may include operations, features, means, or instructions for receiving a signal that multiplexes the control message with a first message associated with the UE.

In some examples of the method, apparatuses, and non-transitory computer-readable medium described herein, communicating the control message may include operations, features, means, or instructions for communicating the control message via one or more time-frequency resources that may be scheduled for feedback associated with the control signaling.

In some examples of the method, apparatuses, and non-transitory computer-readable medium described herein, communicating the control message may include operations, features, means, or instructions for communicating the control message that may be a scheduling request, the scheduling request triggered in response to transmitting the control signaling.

In some examples of the method, apparatuses, and non-transitory computer-readable medium described herein, the wake up signal indicates the first configuration.

Some examples of the method, apparatuses, and non-transitory computer-readable medium described herein may further include operations, features, means, or instructions for receiving, from the first radio or from the WUR of the UE, an indication of a size of a guard band for the wake-up signal, where transmitting the wake-up signal may be based on receiving the indication.

Some examples of the method, apparatuses, and non-transitory computer-readable medium described herein may further include operations, features, means, or instructions for transmitting, to the UE, an indication of a size of a guard band for the wake-up signal, the size of the guard band based on a class of the WUR of the UE, a preferred guard band size of one or more other UEs, or both, where transmitting the wake-up signal may be based on transmitting the indication.

### BRIEF DESCRIPTION OF THE DRAWINGS

FIG. 1 illustrates an example of a wireless communications system that supports wake-up radio desired configuration based on user equipment (UE) indication in accordance with one or more aspects of the present disclosure.

FIG. 2 illustrates an example of a wireless communications system that supports wake-up radio desired configuration based on UE indication in accordance with one or more aspects of the present disclosure.

FIG. 3 illustrates an example of a signaling timeline that supports wake-up radio desired configuration based on UE indication in accordance with one or more aspects of the present disclosure.

FIG. 4 illustrates an example of a process flow that supports wake-up radio desired configuration based on UE indication in accordance with one or more aspects of the present disclosure.

FIG. 5 illustrates an example of a monitoring scheme that supports wake-up radio desired configuration based on UE indication in accordance with one or more aspects of the present disclosure.

FIG. 6 illustrates an example of a monitoring scheme that supports wake-up radio desired configuration based on UE indication in accordance with one or more aspects of the present disclosure.

FIG. 7 illustrates an example of a monitoring scheme that supports wake-up radio desired configuration based on UE indication in accordance with one or more aspects of the present disclosure.

FIGS. 8 and 9 illustrate block diagrams of devices that support wake-up radio desired configuration based on UE indication in accordance with one or more aspects of the present disclosure.

FIG. 10 illustrates a block diagram of a communications manager that supports wake-up radio desired configuration based on UE indication in accordance with one or more aspects of the present disclosure.

FIG. 11 illustrates a diagram of a system including a device that supports wake-up radio desired configuration based on UE indication in accordance with one or more aspects of the present disclosure.

FIGS. 12 and 13 illustrate block diagrams of devices that support wake-up radio desired configuration based on UE indication in accordance with one or more aspects of the present disclosure.

FIG. 14 illustrates a block diagram of a communications manager that supports wake-up radio desired configuration based on UE indication in accordance with one or more aspects of the present disclosure.

FIG. 15 illustrates a diagram of a system including a device that supports wake-up radio desired configuration based on UE indication in accordance with one or more aspects of the present disclosure.

FIGS. 16 and 17 illustrate flowcharts showing methods that support wake-up radio desired configuration based on UE indication in accordance with one or more aspects of the present disclosure.

### DETAILED DESCRIPTION

In some wireless communications systems, a user equipment (UE) may perform communications in various power states. For example, the UE may be operable to cycle a main radio between a first power state (e.g., an ON state) and a second power state (e.g., an OFF state or a deep sleep state). In some cases, such as when the UE communicates data relatively infrequently, the UE may transition the main radio from the first power state to the second power state (e.g., to reduce power consumption). While operating the main radio in the second power state, the UE may periodically monitor a wireless channel using a low-power (LP) wake-up radio (LP-WUR). In some cases, a network entity may transmit a LP wake-up signal (LP-WUS) to indicate upcoming data communications for the UE. For example, the UE may receive the LP-WUS while monitoring using the LP-WUR and may transition the main radio from the second power state to the first power state to support the upcoming data communications. In some cases, however, a configuration of the WUR may be relatively static, which may reduce a flexibility of the communications system.

To support dynamic WUR configuration for a UE, a network entity may transmit an indication of one or more WUR configurations to the UE. In some cases, the UE may identify a desired WUR configuration from the one or more WUR configurations, and may communicate the desired WUR configuration with the network entity. For example, the UE may indicate a request for the desired WUR configuration (e.g., via a dedicated signal), may multiplex the request with another signal associated with the UE (e.g., feedback messages, scheduling requests, UE reporting messages, or the like), or both. Additionally, or alternatively, the network entity may indicate a single WUR configuration to the UE, which may be determined according to desired configurations, a class of WUR, or both associated with a group of UEs (e.g., including the UE). Such techniques may support a reduced overall power expenditure of the UE by improving WUR operation.

Aspects of the disclosure are initially described in the context of wireless communications systems. Aspects of the disclosure are further illustrated by and described with reference to a signaling timeline and a process flow. Aspects of the disclosure are further illustrated by and described with reference to apparatus diagrams, system diagrams, and flowcharts that relate to WUR desired configuration based on UE indication.

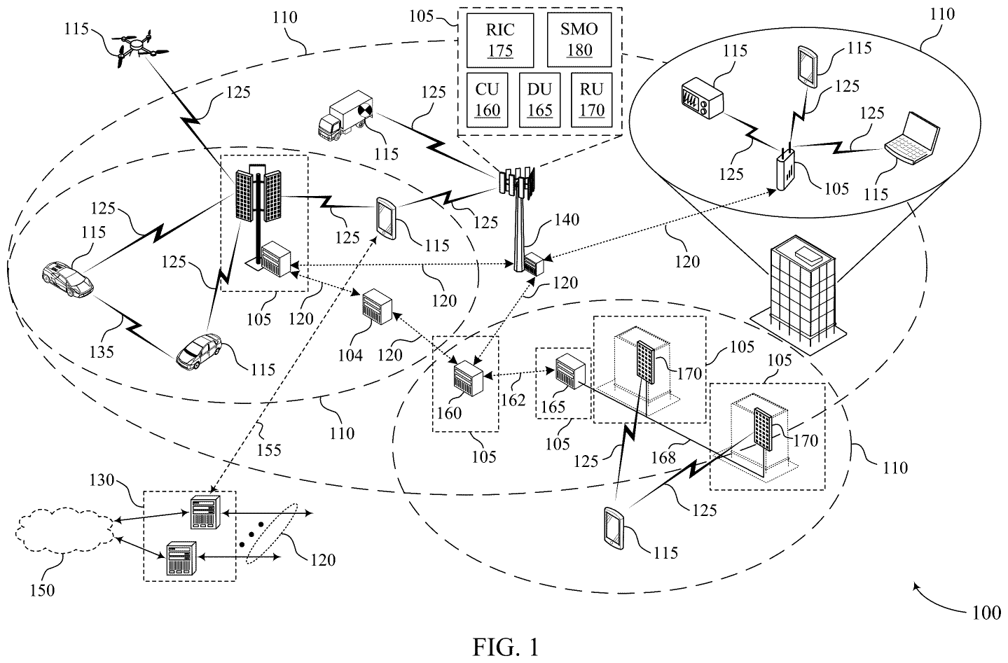

FIG. 1 illustrates an example of a wireless communications system 100 that supports WUR desired configuration based on UE indication in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support WUR desired configuration based on UE indication as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some systems, such as the wireless communications system 100, a UE 115 may perform communications in various power states. For example, the UE 115 may be operable to cycle a main radio between a first power state (e.g., an ON state) and a second power state (e.g., an OFF state or a deep sleep state). While operating the main radio in the second power state, the UE 115 may periodically monitor a wireless channel using a low-power (LP) wake-up radio (LP-WUR). In some cases, a network entity 105 may transmit a LP wake-up signal (LP-WUS) to indicate upcoming data communications for the UE 115. In some cases, however, a configuration of the WUR may be relatively static, which may reduce a flexibility of the system.

To support dynamic WUR configuration for a UE 115, a network entity 105 may transmit an indication of one or more WUR configurations to the UE 115. In some cases, the UE 115 may identify a desired WUR configuration from the one or more WUR configurations, and may communicate the desired WUR configuration with the network entity 105. For example, the UE 115 may indicate a request for the desired WUR configuration (e.g., via a dedicated signal), may multiplex the request with another signal associated with the UE 115 (e.g., feedback messages, scheduling requests, reporting messages, or the like), or both. Additionally, or alternatively, the network entity 105 may indicate a single WUR configuration to the UE 115, which may be determined according to desired configurations, a class of WUR, or both associated with a group of UEs 115 (e.g., including the UE 115). Such techniques may support a reduced overall power expenditure of the UE 115 by improving WUR operation.

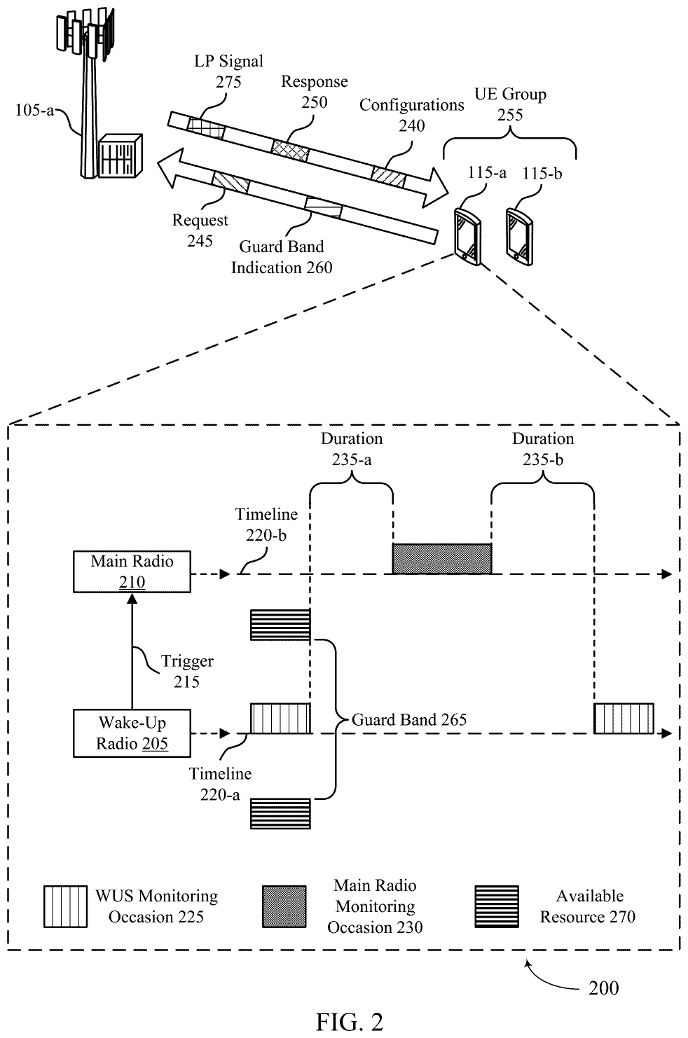

FIG. 2 illustrates an example of a wireless communications system 200 that supports WUR desired configuration based on UE indication in accordance with one or more aspects of the present disclosure. The wireless communications system 200 may implement one or more aspects of the wireless communications system 100. For example, the wireless communications system 200 may include a network entity 105-a, a UE 115-a, and a UE 115-b, which may be examples of corresponding devices described with reference to FIG. 1. In some cases, the wireless communications system 200 may support various techniques for communicating a desired configuration for a WUR of a UE 115, such as a WUR 205, which may support improved power management for the UE 115.

In some cases, a UE 115 may include one or more radios to support communications with the network entity 105-a. For example, the UE 115-a may include a WUR 205 and a main radio 210, which may each perform communications with the network entity 105-a. The UE 115-b may include similar components (e.g., a respective WUR and a respective main radio). In some cases, the WUR 205 may be an example of a relatively simple radio receiver circuit (e.g., a non-coherent envelope detector) and may be associated with relatively low energy consumption. For example, WUR 205 may support a lower energy consumption than a duty-cycling scheme (e.g., avoiding unnecessary waking of the main radio 210 for monitoring a physical downlink control channel (PDCCH)) and may satisfy a latency constraint due to frequently monitoring for a LP-WUS. Additionally, the WUR 205 may include a transceiver with transmission capabilities (e.g., a backscatter device or a radio frequency identification (RFID) tag radio).

In some examples, the WUR 205 may be a separate radio from the main radio 210 or may be a subset of the main radio 210 (e.g., the WUR 205 may be a part of the main radio 210 when hardware, software, firmware, or radio frequency components of the main radio 210 are turned off). In some cases, the WUR 205 may be an example of an ambient IoT radio (e.g., at certain power saving modes or certain times). In such examples, the WUR 205 may operate simultaneously with the main radio 210. For example, the WUR 205 may operate while the main radio 210 is in a connected mode (e.g., to support eMMB and XR applications) in addition to operating while the main radio 210 is in an idle or inactive mode (e.g., a deep sleep state, an ultra-low power state, or an OFF state). In some cases, an example of the ambient IoT radio may be a tag or an RFID tag. In some examples, the ambient IoT radio may be a single radio (e.g., not associated with a separate main radio 210), and may perform signaling with the network entity 105-a using a transceiver of the ambient IoT radio. The ambient IoT radio may be a passive IoT device (e.g., no energy storage, no signal generation, and no amplification), a semi-passive IoT device (e.g., energy storage, no signal generation, and with or without amplification (e.g., low-noise amplifier (LNA) or PA)), or an active IoT device (e.g., energy storage and signal generation).

In some cases, such as when the UE 115-a is communicating data with the network entity 105-a, the UE 115-a may operate the main radio 210 in an ON state (e.g., a first power state). In some other cases, such as when the UE 115-a is waiting to communicate data with the network entity 105-a, the UE 115-a may operate the main radio 210 in an OFF state (e.g., a second power state). While the main radio 210 is operating in the OFF state, the UE 115-a may monitor a wireless channel for LP signaling, such as a LP-WUS, using the WUR 205, which may support reduced energy consumption (e.g., in comparison to the main radio 210). In some cases, the UE 115-a may receive a LP-WUS (e.g., by the WUR 205), which may indicate a trigger 215 to transition the main radio 210 to the ON state (e.g., for transmitting or receiving subsequent data communications). For example, the network entity 105-a may transmit the LP-WUS if there is paging for the UE 115-a while the UE 115-a is in an idle or inactive mode. Additionally, or alternatively, the LP-WUS may include a payload of one or more bits (e.g., addressing information) and may include a WUR preamble (e.g., supporting WUR detection, automatic gain control (AGC), and symbol timing recovery). In some cases, one or more CRC bits may be appended to the LP-WUS payload, which may support payload protection. In some cases, the WUR 205 may not receive a LP-WUS during a monitoring occasion, and may maintain the main radio 210 in the OFF state (e.g., before monitoring again according to a WUS monitoring occasion periodicity).

In some examples, the UE 115-a may operate the WUR 205 and the main radio 210 according to a timeline 220-a and a timeline 220-b, respectively. For example, the WUR 205 may monitor for a LP-WUS during a WUS monitoring occasion 225 (e.g., while operating the main radio 210 in the OFF state). In some cases, the WUR 205 may not detect a LP-WUS during the WUS monitoring occasion 225, may maintain the main radio 210 in the OFF state, and may periodically monitor for a LP-WUS during subsequent WUS monitoring occasions 225 according to a WUS monitoring periodicity or a discontinuous reception (DRX) cycle (e.g., a LP-WUR-DRX configuration). For example, a DRX cycle for the WUR 205 may indicate a cycle duration and an active time duration, where the active time duration may be used for monitoring for a LP-WUS and other LP signals. In some cases, a WUS monitoring occasion 225 may include at least one resource set which may include at least one resource for LP signals.

In some cases, the WUR 205 may receive a LP-WUS during the WUS monitoring occasion 225, and may transition the main radio 210 to the ON state during a duration 235-a (e.g., a main radio 210 wake-up time). The main radio 210 may then monitor for communications from the network entity 105-a (e.g., control messages, data transmissions, or both) during a main radio monitoring occasion 230. In some cases, the main radio monitoring occasion 230 may be indicated by the LP-WUS received during a prior WUS monitoring occasion 225. The main radio monitoring occasion 230 may correspond to a duration of time for the main radio 210 to monitor for a synchronization signal block (SSB) for synchronization and monitor for, and possibly receive, paging during a paging occasion (PO). In some cases, the main radio 210 may finish communicating data with the network entity 105-a, and may transition to the OFF state during a duration 235-b (e.g., a transition time before a next WUS monitoring occasion 225).

The UE 115-a may operate the WUR 205 according to various configurations for receiving LP signals (e.g., a LP-WUS, a LP reference signal (LP-RS), or a LP synchronization signal (LP-SS)). In some cases, a configuration may indicate one or more parameters associated with LP signals, such as a periodicity, a repetition of symbols, a quantity of symbols, a type of waveform, a modulation and coding scheme (MCS), a coding type, a coding rate, power boosting information (e.g., a power boosting coefficient), a time-frequency resource allocation, a guard band, or any combination thereof. Additionally, or alternatively, a configuration may indicate a start of a WUR monitoring occasion and an end of the WUR monitoring occasion. In some cases, the network entity 105-a may dynamically switch a configuration for the WUR 205 (e.g., according to a reliability of upcoming traffic, a desired sensitivity of the WUR 205, a location of the UE 115-a, one or more channel parameters, or a combination thereof).

In some cases, LP signals may be communicated via resource sets which share common configuration parameters. Such parameters may include a quantity of slots, a quasi co-location (QCL) source (e.g., a reference signal monitored by the WUR 205 (e.g., LP-RS, LP-SS), transmitted by the WUR 205, or monitored by the main radio 210 (e.g., CSI-RS, SSB, SRS, or the like)), a time domain symbol pattern (e.g., including a starting symbol in a first slot), an identifier (ID) for a set of LP signals (e.g., LP-WUS/LP-SS/LP-RS/other LP signals), a frequency domain resource block (RB) pattern (e.g., a quantity of RBs and a starting RB), a resource element (RE) pattern (e.g., an RE interval and a starting RE in a RB), a transmission power, a repetition factor of the resource set within a period or time window, a periodicity of the resource set, a guard band, or any combination thereof. In some cases, parameters may be configured for each LP signal resource (e.g., per LP-WUS, LP-SS, and LP-RS). Such parameters may include a starting RE offset in a RB, a staring symbol in a first slot, a generation ID (e.g., a scrambling ID) for LP signals (e.g., LP-WUS/LP-SS/LP-RS/other LP signals), a periodicity of the resource, a repetition factor of the resource, a difference in transmit power relative to an associated resource set (or a resource set configuration parameter may be used) (e.g., a delta transmit power), additional guard band information (e.g., guard band may be a general configuration, part of a resource set configuration, or part of a resource configuration), or any combination thereof.

To support dynamic configuration for the WUR 205, the network entity 105-a may identify a configuration according to an indication from a UE 115. In some cases, the network entity 105-a may indicate a set of one or more configurations 240 to the UEs 115. For example, the main radio 210 may receive (e.g., while operating in the ON state), control signaling from the network entity 105-a indicating multiple configurations 240 for the WUR 205. In some examples, the UE 115-a may select one or more desired configurations of the multiple configurations 240 (e.g., selecting a single configuration or down selecting a subset of the configurations 240), and may indicate the one or more desired configurations to the network entity 105-a in a request 245. Additionally, or alternatively, the request 245 may indicate an activation or a deactivation of one or more configurations for receiving a LP-WUS, a LP-RS, a LP-SS, or a combination thereof. In some cases, the UE 115-a may transmit the request 245 prior to transitioning the main radio 210 to the OFF state. In some examples, the network entity 105-a may transmit a response 250 to the UE 115-a, which may indicate an approval to use at least a first configuration from the one or more desired configurations indicated in the request 245.

In some cases, the network entity 105-a may request that the UE 115-a indicate the one or more desired configurations (e.g., from the configurations 240 or form configurations indicated in the request). In some cases, the request may be transmit via L1 control signal (e.g., a scheduling DCI or a non-scheduling DCI, a PDCCH skipping message, a downlink end of burst indication, or a groupcast PDSCH message), via L2 signaling (e.g., a MAC-CE, multiplexed with a DRX command MAC-CE, or multiplexed with a long DRX command MAC-CE), via L3 signaling (e.g., an RRC release message or an RRC configuration message), via a broadcast message transmitted to the UE group 255 (e.g., a RACH message, an MIB, an SIB1, an OSIB, or a combination thereof), or any combination thereof.

In some cases, the one or more desired configurations may be associated with an RRC state of the UE 115-a. For example, the UE 115-a may indicate a first desired configuration for an RRC idle state, may indicate a second desired configuration for an RRC inactive state, and may indicate a third desired configuration for an RRC connected state. The desired configurations may be signaled in the RRC idle state, the RRC inactive state, or the RRC connected state (e.g., using compatible signaling). In some cases, prior to transitioning to the RRC inactive state (e.g., prior to an RRC inactivity time expiring, triggering a transition from the RRC connected state to the RRC inactive state) the UE 115-a may indicate the second desired configuration for the RRC inactive state. Similarly, prior to transitioning to the RRC idle state (e.g., prior to an RRC idle timer expiring or the network entity 105-a transmitting an RRC release message (e.g., triggering a transition from the RRC connected state to an RRC release state)), the UE 115-a may indicate the first desired configuration for the RRC idle state. The UE 115-a may indicate the desired configurations via L1, L2, or L3 signaling, or may multiplex the indication with L1, L2, or L3 messages, including UE assistance information (UAI), associated with the UE 115-a. In some cases, uplink resources used for the indication may be included in an RRC connection release message (e.g., transmitted by the network entity 105-a in an RRC release message). In an example, the an RRC CONNECTION RELEASE message may be used to command the release of an RRC connection. The network entity (e.g., E-UTRAN) may initiate the RRC connection release procedure to an UE in RRC_CONNECTED state. The indication may be transmitted within a timer period (e.g., the RRC inactive timer or the RRC idle timer), or may be transmitted after the timer period via known resources (e.g., based on a configuration agreement between the network entity 105-a and the UE 115-a).

In some cases, the UE 115-a may transmit the request 245 from the WUR 205 or the main radio 210. For example, the WUR 205 may transmit, from a transmission side of a transceiver associated with the WUR 205, the request 245 via a dedicated signal (e.g., a PHY layer signal). Additionally, or alternatively, the main radio 210 may transmit the request 245 using L1, L2, or L3 signaling (e.g., using dedicated physical uplink control channel (PUCCH) or physical uplink shared channel (PUSCH) resources), or by multiplexing the request 245 with L1, L2, or L3 signaling associated with the UE 115-a. In some examples, the dedicated PUCCH resources (e.g., other than HARQ-ACK PUCCH resources) may be used to send the request 245 to indicate one or more desired configurations. In some examples, the network entity 115 may configure the dedicated resources using L1 signaling, L2 signaling, L3 signaling, or any combination thereof. In some examples, the network entity 115 may indicate the dedicated resource in a PDCCH skipping message, in an end of burst indication (e.g., end of burst control signal), a (long) DRX command (e.g., via MAC-CE), an RRC release message, or the like.

In an example, the main radio 210 may multiplex the request 245 with radio resource control (RRC) signaling, a channel state information (CSI), HARQ feedback resources for a PDSCH, a power headroom report (PHR), a buffer status report (BSR), a scheduling request occasion, a random access channel (RACH) message, a medium access control (MAC) control element (MAC-CE) (e.g., a UL MAC-CE), a UE assistance information (UAI) message (e.g., via RRC signaling), an uplink end of burst indication from UE (e.g., if the network entity 105-a transmits a downlink end of burst indication), a response to a WUS received by the UE 115-a (e.g., using the main radio 210 or the WUR 205), a part of a cell-specific WUS from the UE 115-a to the network entity 105-a, a WUR transmission resource, one or more small data transmission (SDT) resources, or a combination thereof. In some examples, the UE 115-a may transition the main radio 210 to the ON state to update a configuration of the WUR according to one or more conditions, such as a traffic prediction, a location of the UE 115-a (e.g., a far cell), a mobility condition, an observed interference, or a combination thereof.

In some examples, the UE 115-a may multiplex the request 245 with feedback resources scheduled for the UE 115-a. For example, the UE 115-a may receive control signaling scheduling data communications and HARQ resources associated with the data communications. Additionally, or alternatively, the feedback resources may be associated with the end of a burst indication received from the network entity 105-a. The UE 115-a may transmit various bit combinations via the HARQ resources, which may indicate the one or more desired configurations identified by the UE 115-a.

Table 1 below includes a first example of a codebook supporting multiplexing the request 245 with a feedback message:

TABLE 1

| Codepoint | Indicated Information |
|---|---|
| 00 | ACK |
| 01 | NACK + Desired WUR Configuration 1 |
| 10 | NACK + Desired WUR Configuration 2 |
| 11 | NACK + Desired WUR Configuration 3 |

Table 2 below includes a second example of a codebook supporting multiplexing the request 245 with feedback resources:

TABLE 2

| Codepoint | Indicated Information |
|---|---|
| 00 | NACK |
| 01 | ACK + Desired WUR Configuration 1 |
| 10 | ACK + Desired WUR Configuration 2 |
| 11 | ACK + Desired WUR Configuration 3 |

Table 3 below includes a third example of a codebook supporting multiplexing the request 245 with a feedback message:

TABLE 3

| Codepoint | Indicated Information |
|---|---|
| 00 | NACK + Desired WUR Configuration 1 |
| 01 | NACK + Desired WUR Configuration 2 |
| 10 | ACK + Desired WUR Configuration 1 |
| 11 | ACK + Desired WUR Configuration 2 |

It should be noted that the UE 115-a may use a number of possible codebooks for multiplexing the request 245 with feedback resources, and is not limited to the examples provided by Table 1, Table 2, and Table 3.

In another example, the UE 115-a may multiplex the request 245 with a scheduling request. In some cases, the UE 115-a may identify upcoming data communications and may transmit a scheduling request via a scheduling request occasion. For example, the UE 115- may identify the arrival of data in an empty buffer, may identify high-priority data, or both, and may determine the scheduling request occasion for transmission of the scheduling request (e.g., requesting the network entity 105-a to schedule an uplink transmission). In some cases, the network entity 105-a may configure scheduling request occasions according to one or more logical channel identifiers (LC-IDs), one or more logical channel group identifiers (LCG-IDs), or both. For example, the network entity 105-a may configure a first set of scheduling request occasions for a first set of LCG-IDs (e.g., LCG-ID 0 and LCG-ID 1) and may configure a second set of scheduling request occasions for a second set of LCG-IDs (e.g., LCG-ID 2 and LCG-ID 3). The UE 115-a may determine which scheduling request occasion to use for transmission of the scheduling request based on the LC-ID or LCG-ID associated with the data. For example, the UE 115-a may use a scheduling request occasion from the first set of scheduling request occasions if the data is associated with one of the first set of LCG-IDs or may use a scheduling request occasion from the second set of scheduling request occasions if the data is associated with one of the second set of LCG-IDs. In some cases, the UE 115-a may receive a non-scheduling downlink control information (DCI) (e.g., a DCI without a deterministic uplink resource) which may trigger the scheduling request.

Table 4 below includes a first example of a codebook supporting multiplexing the request 245 with a scheduling request:

TABLE 4

| Codepoint | Indicated Information |
|---|---|
| 00 | Negative Scheduling Request |
| 01 | Positive Scheduling Request + Desired WUR Configuration 1 |
| 10 | Positive Scheduling Request + Desired WUR Configuration 2 |
| 11 | Positive Scheduling Request + Desired WUR Configuration 3 |

Table 5 below includes a second example of a codebook supporting multiplexing the request 245 with a scheduling request:

TABLE 5

| Codepoint | Indicated Information |
|---|---|
| Nothing | Negative Scheduling Request |
| 00 | Positive Scheduling Request + Desired WUR Configuration 1 |
| 01 | Positive Scheduling Request + Desired WUR Configuration 2 |
| 10 | Positive Scheduling Request + Desired WUR Configuration 3 |
| 11 | Positive Scheduling Request + Desired WUR Configuration 4 |

It should be noted that the UE 115-a may use a number of possible codebooks for multiplexing the request 245 with a scheduling request, and is not limited to the examples provided by Table 4 and Table 5.

In some examples, the UE 115-a may indicate, with the one or more desired configurations, additional information in the request 245. For example, the UE 115-a may indicate, in the request 245, a sleeping time associated with the main radio 210, a type of the sleeping time, a first time duration between receiving a LP-WUS by the WUR 205 and transitioning the main radio 210 to the ON state (e.g., the duration 235-a), a second time duration between transitioning the main radio 210 to the OFF state and a next WUS monitoring occasion 225 (e.g., the duration 235-b), or a combination thereof. Additionally, or alternatively, the UE 115-a may indicate, in the request 245, a desired type of a LP-WUS (e.g., a PDCCH indication, on-off keying (OOK), or a sequence based signal), a desired type of a LP-RS, a desired type LP-SS, or a combination thereof to monitor for during a WUS monitoring occasion 225. As a response to PDCCH skipping (so a new UL feedback resources may be allocated for a feedback of DCI) or multiplexed with the HARQ-ACK resources of the PDSCH scheduled by the PDCCH skipping (note that PDCCH skipping is a scheduling DCI), UE can indicate the above information (e.g., sleeping time, desired WUR configuration, time when the WUR will start to monitor for LP signals).

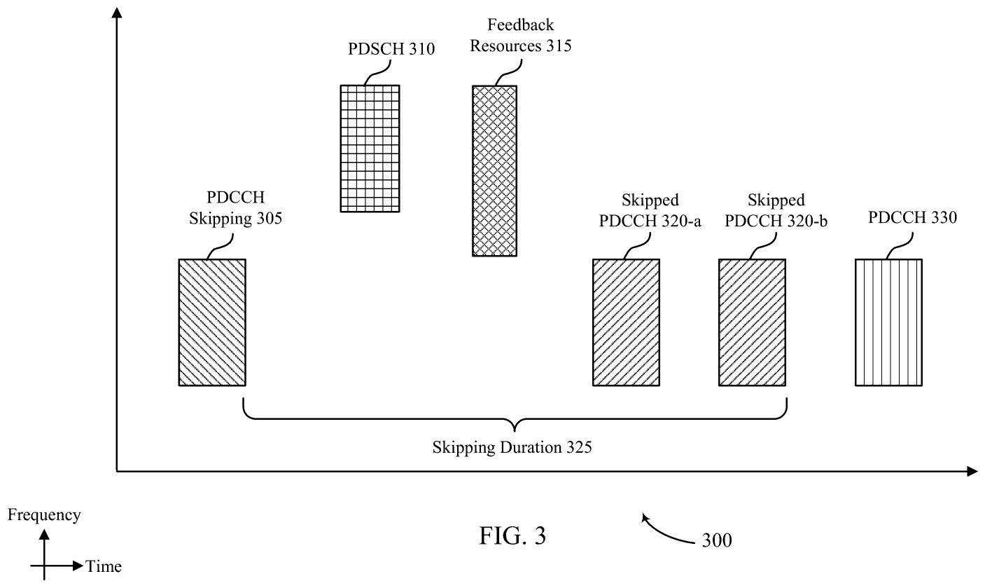

In some cases, the network entity 105-a may transmit, to the UE 115-a, an indication (e.g., a L1, L2, or L3 signal) enabling the UE 115-a to report the one or more desired configurations in the request 245. For example, the network entity 105-a may transmit a DCI indicating (e.g., a bit indication or a radio network temporary identifier (RNTI)) that the UE 115-a is to report the one or more desired configurations. In some cases, the DCI may further indicate a multiplexing configuration for the reporting (e.g., HARQ multiplexing, scheduling request multiplexing, or multiplexing with other PUCCH resources). In an example, scheduling DCI (e.g., PDCCH or others) may include one or more bits, or a RNTI, or configuration to enable desired WUR config reporting with at least one or more of an L1 signal, or an L2 signal, or an L3 signal, or any combination thereof. The DCI can indicate whether WUR config is multiplexed with the same resources as, for example, HARQ-ACK resources, SR resources, or other PUCCH resources. In some examples, the network entity 105-a may use a PDCCH skipping message to indicate one or more configurations, as described further with reference to FIG. 3. Additionally, or alternatively, the network entity 105-a may use a downlink end of burst indication (e.g., transmit via L1, L2, or L3 signaling), a DRX command (e.g., a long DRX command via MAC-CE), or a RRC release message to indicate the one or more configurations.

Additionally, or alternatively, the network entity 105-a may indicate a single configuration via a LP signal 275. For example, the network entity 105-a transmit, to the UE 115-a, an indication of the configuration using a LP-RS (e.g., multiplexed with one or more bits of the LP-RS), a LP-SS, a LP-WUS, or a combination thereof (e.g., a LP-RS sequence may point to a set of parameters indicate by a LP-WUS or another LP signal). In some other examples, the network entity 105-a may indicate the configuration using a new LP signal (e.g., a signal similar to a LP-WUS), which may be a unicast, a groupcast, or a broadcast message. Any combination of these signals may also be used to indicate the configuration (e.g., an LP-RS sequence points to a set of parameters that could be indicated by LP-WUS or another low power signal).

In some examples, the network entity 105-a may determine a configuration for the WUR 205 according to one or more desired configurations of multiple UEs 115, a class of WURs associated with the multiple UEs 115, or both. For example, the network entity 105-a may determine a WUR configuration for a UE group 255, which may include the UE 115-a and the UE 115-b, based on the one or more desired configurations reported by the UE 115-a (e.g., in the request 245) and one or more desired configurations reported by the UE 115-b. Additionally, or alternatively, the network entity 105-a may determine a WUR configuration for the UE group 255 based on a class of the WURs associated with the UE 115-a and the UE 115-b. For example, the class of the WUR 205 may indicate processing information for the WUR 205, such as a type of supported signaling, filtration information, modulation information, supported waveforms, coding information, transmission capabilities, a clock accuracy for the UE 115-a, or a combination thereof. In some cases, the network entity 105-a may perform additional synchronization for WURs having a clock with relatively low accuracy.

In some examples, the UE 115-a may transmit a guard band indication 260 to the network entity 105-a, which may indicate a preferred guard band for receiving LP signaling (e.g., a LP-WUS, a LP-RS, or a LP-SS) by the WUR 205. For example, the guard band indication 260 may include a size of a guard band 265, which may indicate a gap between frequency resources used for WUS monitoring occasions 225 and available resources 270 (e.g., resources available for other communications). The main radio 210 of the UE 115-a may transmit the guard band indication or the WUR 205 may transmit the guard band indication (e.g., if the WUR 205 includes a transmission side). In an example, the UE 115-a may indicate a desired or needed guard band size for the WUR 205 for one or more of a wake-up signal, for a reference signal, for a synchronization signal, or any combination therefore, periodically or from time to time. In some cases, the UE 115-a may indicate the size of the guard band 265 via uplink resources, RRC signaling, an uplink MAC-CE, a UAI message, or a combination thereof. Additionally, or alternatively, the UE 115-a may indicate the size of the guard band 265 by multiplexing the guard band indication 260 with a feedback message (e.g., a last HARQ occasion before going to sleep, prior to an end of a discontinuous reception (DRX) inactivity timer within a last DRX cycle, or triggered by a scheduling DCI), a scheduling request, a BSR, a RACH message, an uplink end of burst indication from the UE 115-a (e.g., if the network entity 105-a transmits a downlink end of burst indication), a PHR, a cell-specific WUS, a response to a WUS received by the main radio 210 or the WUR 205, or a combination thereof. In some examples, the network entity 105-a may determine a guard band for the UE group 255 based on a preferred guard band reported by the UE 115-a and a preferred guard band reported by the UE 115-b. For example, the network entity 105-a can decide a size of a gap as a guard band based on desired gaps from multiple UEs or based on WUR class of one or more UEs in a UE group. In some cases, the network entity 105-a may identify one or more potential gaps or guard bands for the UE group 255 during an initial access procedure (e.g., based on a master information block (MIB), a system information block (SIB), or an other system information block (OSIB)). In some cases, the one or more potential guard bands may be based on the WUR class associated with each UE 115 of the UE group 255. The network entity 105-a may select a guard band from the one or more potential guard bands for performing communications with each UE or with the UE group 255, and may dynamically update the guard band for each UE 115 or for the UE group 225 according to the preferred guard band reported by one or more of the UEs 115, or one or more other conditions such as a mobility of one or more of the UEs 115, a location of one or more of the UEs 115 (e.g., a near cell or a far cell), an interference measured by one or more of the UEs 115, traffic associated with one or more of the UEs 115, or a combination thereof. In some examples, the UE 115-a may include, in the guard band indication 260, a delta value indicating a difference from a previous guard band configured for the WUR 205.

Table 6 below includes a first example of a codebook supporting multiplexing the guard band indication 260 with a feedback message:

TABLE 6

| Codepoint | Indicated Information |
|---|---|
| 00 | ACK |
| 01 | NACK + Guard Band Configuration 1 or Delta Guard Band 1 |
| 10 | NACK + Guard Band Configuration 2 or Delta Guard Band 2 |
| 11 | NACK + Guard Band Configuration 3 or Delta Guard Band 3 |

Table 7 below includes a second example of a codebook supporting multiplexing the guard band indication 260 with a feedback message:

TABLE 7

| Codepoint | Indicated Information |
|---|---|
| 00 | NACK |
| 01 | ACK + Guard Band Configuration 1 or Delta Guard Band 1 |
| 10 | ACK + Guard Band Configuration 2 or Delta Guard Band 2 |
| 11 | ACK + Guard Band Configuration 3 or Delta Guard Band 3 |

Table 8 below includes an example of a codebook supporting multiplexing the guard band indication 260 with a scheduling request:

TABLE 8

| Codepoint | Indicated Information |
|---|---|
| 00 | Negative Scheduling Request |
| 01 | Positive Scheduling Request + Guard Band Configuration |
| | 1 or Delta Guard Band 1 |
| 10 | Positive Scheduling Request + Guard Band Configuration |
| | 2 or Delta Guard Band 2 |
| 11 | Positive Scheduling Request + Guard Band Configuration |
| | 3 or Delta Guard Band 3 |

It should be noted that the UE 115-a may use a number of possible codebooks for multiplexing the guard band indication 260 with another message, and is not limited to the examples provided by Table 6, Table 7, and Table 8.

FIG. 3 illustrates an example of a signaling timeline 300 that supports WUR desired configuration based on UE indication in accordance with one or more aspects of the present disclosure. The signaling timeline 300 may be implemented by one or more aspects of the wireless communications system 100 and the wireless communications system 200. For example, the signaling timeline 300 may depict an example of messages communicated by a UE 115 to support identifying a configuration for a WUR of the UE 115, such as the UE 115-a described with reference to FIG. 2.

In some cases, the UE 115 may receive, from a network entity 105, a message indicating a PDCCH skipping message 305. For example, the UE 115 may receive, via a PDCCH, a DCI indicating the PDCCH skipping message 305 and scheduling a physical downlink shared channel (PDSCH) 310. In some cases, the PDCCH skipping message 305 may indicate that the UE 115-a is to skip monitoring one or more subsequent control channel occasions or may indicate a skipping duration 325. In some cases, the network entity 105 may indicate one or more configurations for the WUR of the UE 115 via the PDCCH skipping message 305. For example, the network entity 105 may reuse one or more fields in the DCI to indicate the one or more configurations or may use a new RNTI to indicate that the PDCCH skipping message 305 includes the one or more configurations.

The UE 115 may receive the PDSCH 310 based on receiving the PDCCH skipping message 305. In some cases, the UE 115 may identify feedback resources 315 associated with the PDSCH 310.

In some examples, such as when the PDCCH skipping message 305 indicates multiple configurations for the WUR, the UE 115 may select one or more desired configurations from the multiple configurations, and may request the one or more desired configurations via the feedback resources 315 (e.g., using multiplexing techniques as described with reference to FIG. 2). In some other examples, such as when the PDCCH skipping message 305 indicates a single configuration for the WUR, the UE 115 may refrain from requesting a desired configuration via the feedback resources 315 (e.g., to avoid redundant signaling).

In some cases, the UE 115 may skip monitoring for one or more PDCCH occasions based on the PDCCH skipping message 305. For example, the UE 115 may refrain from monitoring a skipped PDCCH 320-a and a skipped PDCCH 320-b according to the skipping duration 325 or a quantity of skipped occasions indicated in the PDCCH skipping message 305. The UE 115 may then receive a PDCCH 330 during a PDCCH occasion after the one or more skipped PDCCHs 320.

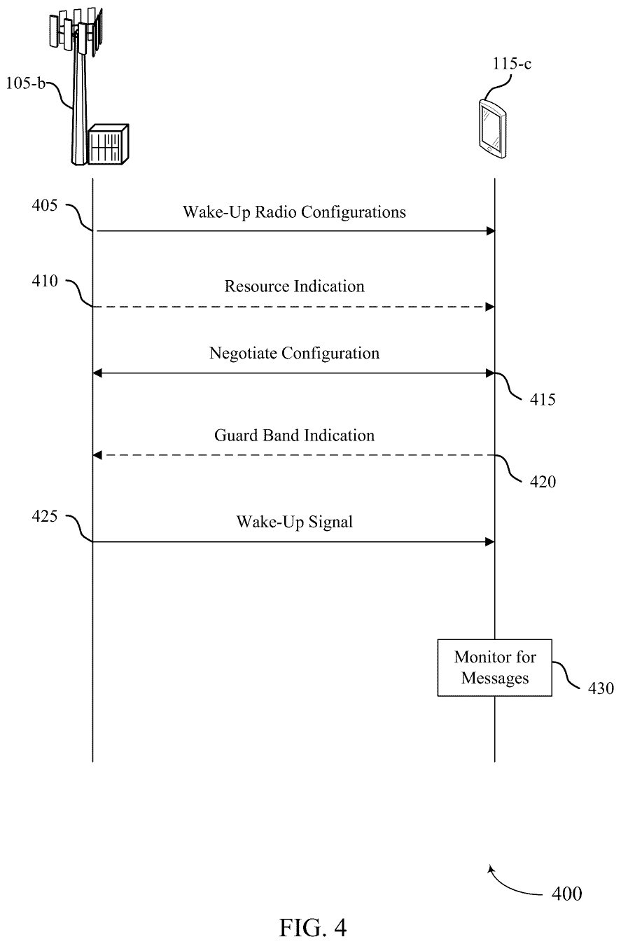

FIG. 4 illustrates an example of a process flow 400 that supports WUR desired configuration based on UE indication in accordance with one or more aspects of the present disclosure. The process flow 400 may be implemented by one or more aspects of the wireless communications system 100 and the wireless communications system 200. For example, the process flow 400 may include signaling between a network entity 105-b and a UE 115-c to support determining a configuration for a WUR of the UE 115-c, which may be examples of the network entity 105-a and the UE 115-a described with reference to FIG. 2. Alternative examples of the following may be implemented, where some processes are performed in a different order than described or are not performed. In some cases, processes may include additional features not mentioned below, or further processes may be added.

At 405, the network entity 105-b may transmit, to the UE 115-c, control signaling indicating at least one configuration for a WUR of the UE 115-c for monitoring for wake-up signaling from the network entity 105-b. In some cases, the UE 115-c may receive the control signaling by a first radio (e.g., a main radio) that is operating in a first power state (e.g., an ON state), and may be operable to cycle the first radio between the first power state and a second power state that uses less power than the first power state (e.g., an OFF state). In some examples, the control signaling may include a request that the UE 115-c indicate one or more desired configurations for the WUR. In some cases, the request may be transmit via L1 control signal (e.g., a scheduling DCI or a non-scheduling DCI, a PDCCH skipping message, a downlink end of burst indication, or a groupcast PDSCH message), via L2 signaling (e.g., a MAC-CE, multiplexed with a DRX command MAC-CE, or multiplexed with a long DRX command MAC-CE), via L3 signaling (e.g., an RRC release message or an RRC configuration message), via a broadcast message transmitted to the UE group 255 (e.g., a RACH message, an MIB, an SIB1, an OSIB, or a combination thereof), or any combination thereof.

In some examples, each configuration of the at least one configuration may indicate a waveform of the wake-up signaling, an MCS of the wake-up signaling, a coding type of the wake-up signaling, a coding rate of the wake-up signaling, a periodicity of the wake-up signaling, a quantity of time-frequency resources associated with the wake-up signaling, a guard band associated with the wake-up signaling, a frequency band of the wake-up signaling, a frequency range of the wake-up signaling, one or more component carriers of the wake-up signaling, one or more bandwidth parts of the wake-up signaling, or any combination thereof. For example, a configuration of WUR may indicate one or more of a frequency band, a frequency range (e.g. frequency range one (FR1) versus FR2 vs other frequency ranges), at least one component carrier (CC) configured for WUR, a certain bandwidth or BWP for the WUR to monitor within the bandwidth within a CC. In some examples, one or more CCs of the main radio and the WUR may be shared, partially overlap, or may be separate CCs. In some examples, if the main radio is using FR2, the WUR may use a different frequency range, such as FR1 or other frequency range, or the WUR may be indicated to use FR1 or use certain band or BWP within FRI or another frequency range.

At 410, the network entity 105-b may transmit, to the UE 115-c, an indication of one or more time-frequency resources for the UE 115-c to use to request a desired configuration for the WUR. For example, the network entity 105-b may indicate the one or more time-frequency resources via a L1 message, a L2 message, a L3 message, a PDCCH skipping message, a burst control signal, a DRX command (e.g., a DRX command MAC-CE or a long DRX command MAC-CE), an RRC release message, or a combination thereof.

At 415, the UE 115-c and the network entity 105-b may communicate a control message to negotiate a configuration for the WUR. For example, the UE 115-c may transmit, to the network entity 105-b, the control message including a request indicating at least a first configuration of the at least one configuration (e.g., one or more desired configurations). The UE 115-c may receive, from the network entity 105-b and by the first radio that is operating in the first power state, a response to the request, the response indicating approval to use at least the first configuration. In some examples, the control message may include an indication of one of a first time duration associated with the first radio transitioning from the second power state to the first power state after receiving the WUS, a second time duration associated with the first radio transitioning from the first power state to the second power state and the UE 115-c starting monitoring for the wake-up signaling by the WUR, or both. In some examples, the control message may indicate a desired type of the wake-up signaling (e.g., PDCCH signaling, OOK, or sequence based signaling).

Additionally, or alternatively, the UE 115-c may transmit a signal that multiplexes the control message with a first message associated with the UE 115-c, where the first message may include feedback message, a scheduling request, a BSR, a RACH message, a CSI message, RRC signaling, a MAC-CE, a UAI message, a PHR, an uplink end of burst indication, a cell-specific WUS, a response to a WUS received by the first radio or the WUR, or any combination thereof. In some cases, such as when the UE 115-c multiplexes the control message with a feedback message, the UE 115-c may identify one or more time-frequency resources that are scheduled for feedback for communicating the control message. For example, the UE 115-c may receive, from the network entity 105-b via a PDCCH, a PDCCH skipping message scheduling transmission of the message via a PDSCH and indicating to skip monitoring of one or more control channel occasions, where the one or more time-frequency resources include a feedback resource for the PDSCH associated with the PDCCH skipping message. As another example, the UE 115-c may receive, from the network entity 105-b, an end of a burst indication associated with transmission of the control message via a PDSCH, where the one or more time-frequency resources comprise a feedback resource associated with the end of the burst indication. In some other cases, such as when the UE 115-c multiplexes the control message with a scheduling request, the UE 115-c may identify a scheduling request occasion for transmitting the scheduling request. In some cases, the scheduling request occasion may be indicated by a DCI (e.g., triggered by a non-scheduling DCI) or may be indicated by a LC-ID or LCG-ID associated with the first configuration.

At 420, the UE 115-c may transmit, to the network entity 105-b, a guard band indication including a preferred size of a guard band for the UE 115-c. The guard band indication may be transmit by the first radio or the WUR, and may be transmit via one or more time-frequency resources that are scheduled for uplink transmission (e.g., including data carried on a PUSCH), RRC signaling, a MAC-CE, a UAI message, a feedback message, a scheduling request, a BSR, a PHR, a RACH message, an SDT, or any combination thereof. In some cases, the network entity 105-b may identify one or more potential guard bands during an initial access procedure (e.g., based on MIB, SIB, or OSIB), and may select a guard band size for the UE 115-c based on a class of the WUR, a preferred guard band size of one or more other UEs, or both. In some examples, the network entity 105-b may dynamically updated the guard band size for the UE 115-c based on a preference of the UE 115-c, a mobility of the UE 115-c, a location of the UE 115-c (e.g., near cell or far cell), interference measured by the UE 115-c, traffic associated with the UE 115-c, or a combination thereof.

At 425, the network entity 105-b may transmit, to the WUR of the UE 115-c when the first radio is operating in the second power state, a WUS in accordance with the first configuration of the at least one configuration, where the WUS may indicate that the UE 115-c is to transition the first radio from the second power state to the first power state. The first configuration may be based on the negotiated configuration between the network entity 105-b and the UE 115-c (e.g., supporting a request for one or more desired configurations. Additionally, or alternatively, the network entity 105-b may directly indicate the first configuration in the WUS (e.g., without negotiating the configurations). In some cases, the UE 115-c may receive the WUS according to the guard band size indicated by the UE 115-c or the network entity 105-b.

At 430, the UE 115-c may monitor, by the first radio that is operating in the first power state, for one or more messages from the network entity 105-b in response to receiving the WUS by the WUR. For example, the UE 115-c may monitor for a SSB, which may synchronize a paging occasion for the UE 115-c to communicate data.

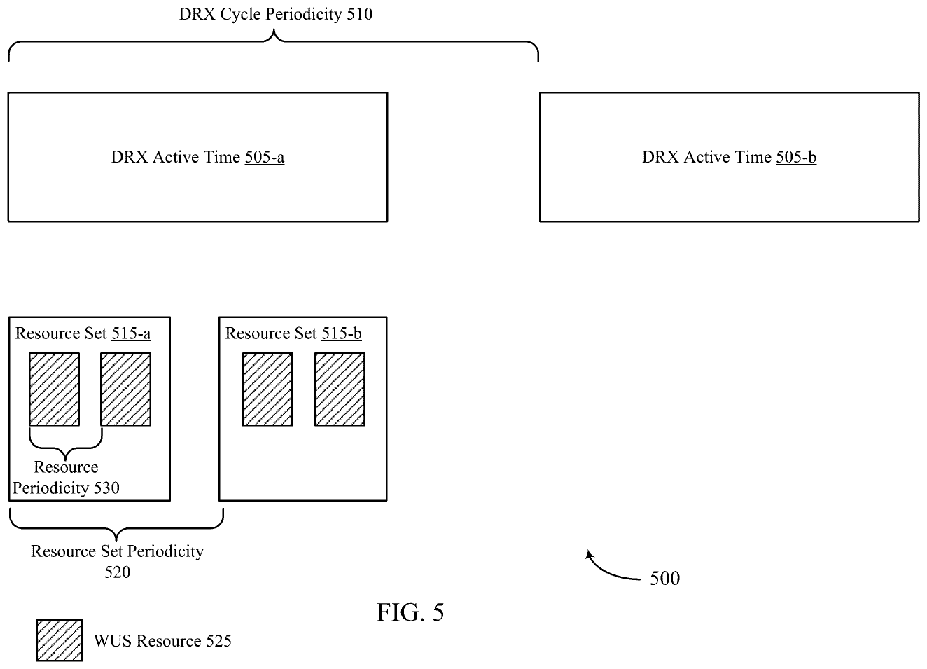

FIG. 5 illustrates an example of a monitoring scheme 500 that supports WUR desired configuration based on UE indication in accordance with one or more aspects of the present disclosure. The monitoring scheme 500 may be implemented by a UE 115 operating a WUR, such as the UE 115-a described with reference to FIG. 2. The UE 115 may operate the WUR according to a DRX cycle. For example, the WUR may operate in an ON state during a DRX active time 505-a and may operate in an OFF state after the DRX active time 505-a and prior to a second DRX active time 505-b (e.g., according to a DRX cycle periodicity 510).

In some cases, the WUR may monitor one or more resource sets 515 during a DRX active time 505 (e.g., the DRX active time 505-a or the DRX active time 505-b). For example, the WUR may monitor a first resource set 515-a and may monitor a second resource set 515-b according to a resource set periodicity 520. Within each resource set 515, the WUR may monitor WUS resources 525 (e.g., LP-WUS resources) according to a resource periodicity 530. For example, each DRX active time 505 may include at least one resource set 515 and each resource set 515 may include at least one WUS resource 525. In some examples, the WUR may monitor for other LP signals, such as a LP-SS or a LP-RS, outside of a DRX active time 510. For example, the other LP signals may be associated with a different configuration or periodicity than the LP-WUS (e.g., for resource sets, resources, and monitoring occasions).

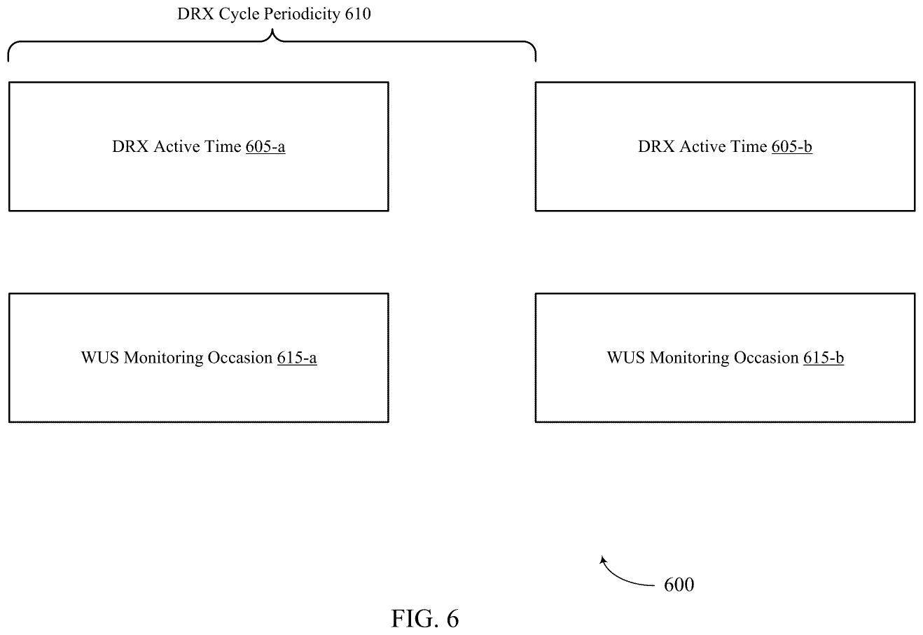

FIG. 6 illustrates an example of a monitoring scheme 600 that supports WUR desired configuration based on UE indication in accordance with one or more aspects of the present disclosure. The monitoring scheme 600 may be implemented by a UE 115 operating a WUR, such as the UE 115-a described with reference to FIG. 2. The UE 115 may operate the WUR according to a DRX cycle. For example, the WUR may operate in an ON state during a DRX active time 605-a and may operate in an OFF state after the DRX active time 605-a and prior to a second DRX active time 605-b (e.g., according to a DRX cycle periodicity 610).

In some cases, the WUR may monitor for one or more LP signals, such as a LP-WUS, a LP-RS, or a LP-SS, during a WUS monitoring occasion 615. In some cases, a WUS monitoring occasion 615 may align with a corresponding DRX active time 605. For example, a WUS monitoring occasion 615-a may align in time with the DRX active time 605-a and a WUS monitoring occasion 615-b may align in time with the DRX active time 605-b. In some examples, each WUS monitoring occasion 615 may include at least one LP-WUS resource.

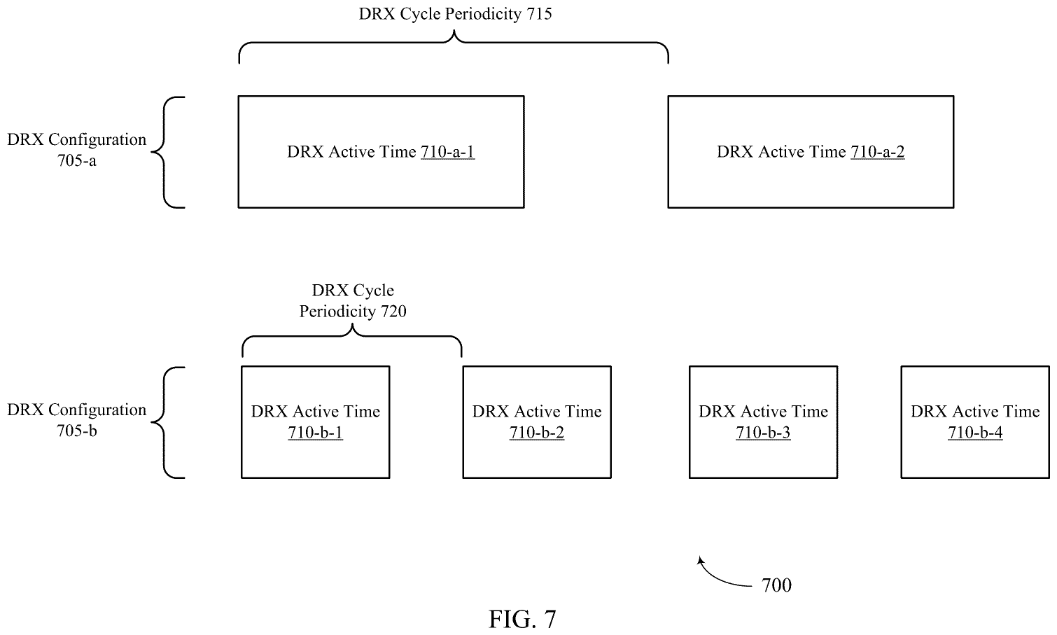

FIG. 7 illustrates an example of a monitoring scheme 700 that supports WUR desired configuration based on UE indication in accordance with one or more aspects of the present disclosure. The monitoring scheme 700 may be implemented by a UE 115 operating a WUR, such as the UE 115-a described with reference to FIG. 2. The WUR may operate according to one or more DRX configurations 705, such as a DRX configuration 705-a or a DRX configuration 705-b. For example, when operating according to the DRX configuration 705-a, the WUR may operate in an ON state during a DRX active time 710-a-1 and may operate in an OFF state after the DRX active time 710-a-1 and prior to a second DRX active time 710-a-2 (e.g., according to a DRX cycle periodicity 715). As another example, when operating according to the DRX configuration 705-b, the WUR may operate in an ON state during a DRX active time 710-b-1 and may operate in an OFF state after the DRX active time 710-b-1 and prior to a second DRX active time 710-b-2 (e.g., according to a DRX cycle periodicity 720). In some examples, a DRX configuration may be a periodic occasions activated once UE starts to monitor using the LP-WUR.

In some cases, the UE is only configured with a LP-WUR-DRX configuration and monitors LP-WUS and other low power signals during an active time of the DRX cycle. The UE may also monitor LP-RS/LP-SS outside that DRX active time and those LP-RSs/LP-SSs have their own configurations and periodicity, etc., including resource sets, resources within a set, monitoring occasions, or any combination thereof.

As part of a desired configuration, the UE may indicate a desired config for LP-WUR-DRX (e.g., periodicity and active time duration). For example, the UE may indicate certain quantities among a set of provided quantities for periodicity, active time duration, or both. The UE may also indicate certain configuration among multiple configurations and may send an index representing which a desired configuration, a desired resource set configuration (e.g., select certain sets among plurality of sets), a desired resource configuration (same as others), or any combination thereof. The UE may select a combination of configurations from previously configured configurations as described herein.

In some cases, the DRX configuration 705-a and the DRX configuration 705-b may be associated with respective types of signaling. For example, the DRX configuration 705-a may be used for monitoring for LP-WUSs or control information and the DRX configuration 705-b may be used for monitoring for LP-RSs and LP-SSs. In some cases, the UE 115 may indicate a desired configuration for the DRX cycle for the WUR (e.g., a periodicity and active time duration). For example, a network entity 105 may indicate one or more candidate configurations to the UE 115, and the UE 115 may request the desired configuration by indicating desired values for the DRX cycle or may indicate an index value representing the desired configuration. In some cases, the UE 115 may indicate a desired configuration for one or more resource sets (e.g., selected form a pool of resource sets), a desired configuration for one or more resources, or both for receiving LP signaling. In some cases, the UE 115 may select a combination of configurations indicated by the network entity 105. In some cases, different configurations may be selected and be desired for different RRC states. For example, the desired configurations may be based on an RRC state for the UE 115 (e.g., an RRC idle state, an RRC inactive state, or an RRC connected state).

In some cases, a WUS monitoring occasion or a DRX active time 710 for the WUR may collide with resources allocated for other signals. In such examples, the UE 115 may monitor for a LP-WUS and may drop the colliding signaling, or may decode one of the colliding signals (e.g., decoding a LP-SS since LP-SS is communicated to multiple UEs 115 and the network entity 105 may continue transmitting the LP-SS). Additionally, or alternatively, the WUR may monitor for a colliding signal, such as a LP-SS, and may drop a LP-WUS (e.g., the LP-WUS may not be sent by the network entity 105). In some cases, the WUR may select signals to monitor for according to a preference, configuration, or implementation. For example, the WUR may identify the presence of both a LP-WUS and a LP-SS, and may monitor one of the signals based on a configuration or preference. In some examples, the WUR may monitor for both of the signals (e.g., due to a capability to monitor for both signals), where the signals may be allocated to different frequency bands or different bandwidths. In some cases, priority handling for colliding signaling may be defined by the network entity 105, or may be pre-defined (e.g., according to a standard).

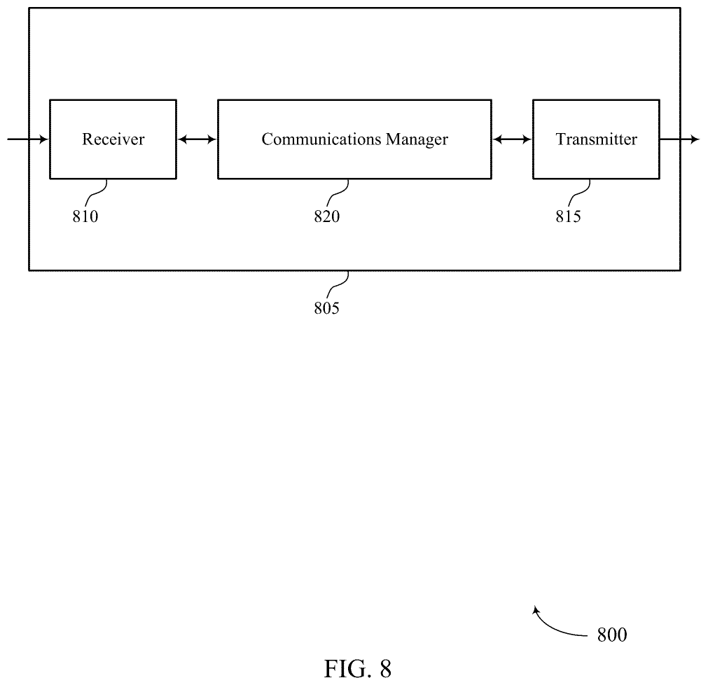

FIG. 8 illustrates a block diagram 800 of a device 805 that supports WUR desired configuration based on UE indication in accordance with one or more aspects of the present disclosure. The device 805 may be an example of aspects of a UE 115 as described herein. The device 805 may include a receiver 810, a transmitter 815, and a communications manager 820. The device 805 may also include one or more processors, memory coupled with the one or more processors, and instructions stored in the memory that are executable by the one or more processors to enable the one or more processors to perform the WUR configuration signaling features discussed herein. Each of these components may be in communication with one another (e.g., via one or more buses).

The receiver 810 may provide a means for receiving information such as packets, user data, control information, or any combination thereof associated with various information channels (e.g., control channels, data channels, information channels related to WUR desired configuration based on UE indication). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to WUR desired configuration based on UE indication). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of WUR desired configuration based on UE indication as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a UE in accordance with examples as disclosed herein. For example, the communications manager 820 may be configured as or otherwise support a means for receiving, by a first radio of the UE that is operating in a first power state, control signaling indicating at least one configuration for a WUR of the UE for monitoring for wake-up signaling from a network entity, the first radio cycling between the first power state and a second power state that uses less power than the first power state. The communications manager 820 may be configured as or otherwise support a means for receiving, by the WUR of the UE when the first radio is operating in the second power state, a wake up signal in accordance with a first configuration of the at least one configuration, the wake up signal indicating to transition the first radio from the second power state to the first power state. The communications manager 820 may be configured as or otherwise support a means for monitoring, by the first radio of the UE that is operating in the first power state, for a message in response to WUR of the UE receiving the wake up signal.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for reduced power consumption by selecting a WUR configuration based on a UE indication.

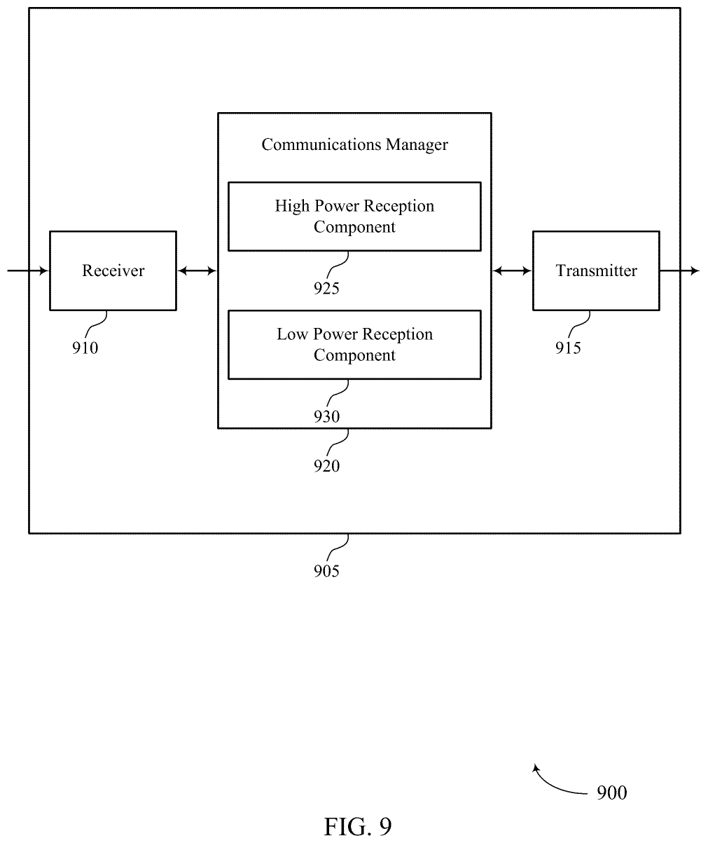

FIG. 9 illustrates a block diagram 900 of a device 905 that supports WUR desired configuration based on UE indication in accordance with one or more aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to WUR desired configuration based on UE indication). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to WUR desired configuration based on UE indication). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of WUR desired configuration based on UE indication as described herein. For example, the communications manager 920 may include a high power reception component 925 a low power reception component 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a UE in accordance with examples as disclosed herein. The high power reception component 925 may be configured as or otherwise support a means for receiving, by a first radio of the UE that is operating in a first power state, control signaling indicating at least one configuration for a WUR of the UE for monitoring for wake-up signaling from a network entity, the first radio cycling between the first power state and a second power state that uses less power than the first power state. The low power reception component 930 may be configured as or otherwise support a means for receiving, by the WUR of the UE when the first radio is operating in the second power state, a wake up signal in accordance with a first configuration of the at least one configuration, the wake up signal indicating to transition the first radio from the second power state to the first power state. The high power reception component 925 may be configured as or otherwise support a means for monitoring, by the first radio of the UE that is operating in the first power state, for a message in response to WUR of the UE receiving the wake up signal.

In some cases, the high power reception component 925 and the low power reception component 930 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the high power reception component 925 and the low power reception component 930 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

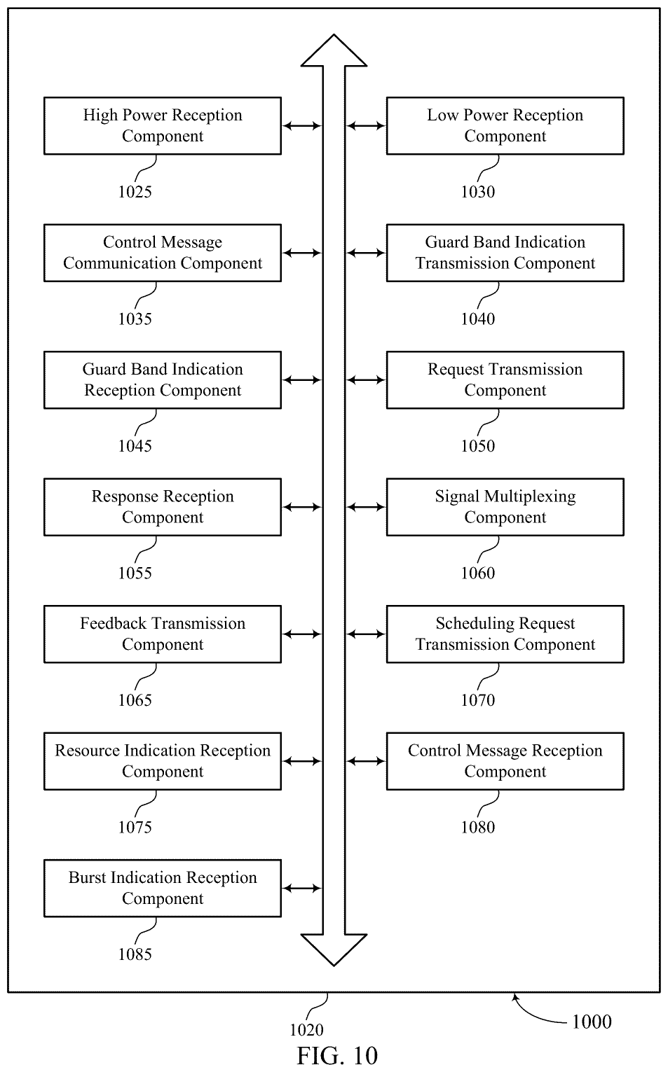

FIG. 10 illustrates a block diagram 1000 of a communications manager 1020 that supports WUR desired configuration based on UE indication in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of WUR desired configuration based on UE indication as described herein. For example, the communications manager 1020 may include a high power reception component 1025, a low power reception component 1030, a control message communication component 1035, a guard band indication transmission component 1040, a guard band indication reception component 1045, a request transmission component 1050, a response reception component 1055, a signal multiplexing component 1060, a feedback transmission component 1065, a scheduling request transmission component 1070, a resource indication reception component 1075, a control message reception component 1080, a burst indication reception component 1085, or any combination thereof. Each of these components may communicate, directly or indirectly, with one another (e.g., via one or more buses).

The communications manager 1020 may support wireless communication at a UE in accordance with examples as disclosed herein. The high power reception component 1025 may be configured as or otherwise support a means for receiving, by a first radio of the UE that is operating in a first power state, control signaling indicating at least one configuration for a WUR of the UE for monitoring for wake-up signaling from a network entity, the first radio cycling between the first power state and a second power state that uses less power than the first power state. The low power reception component 1030 may be configured as or otherwise support a means for receiving, by the WUR of the UE when the first radio is operating in the second power state, a wake up signal in accordance with a first configuration of the at least one configuration, the wake up signal indicating to transition the first radio from the second power state to the first power state. In some examples, the high power reception component 1025 may be configured as or otherwise support a means for monitoring, by the first radio of the UE that is operating in the first power state, for a message in response to WUR of the UE receiving the wake up signal.

In some examples, the control message communication component 1035 may be configured as or otherwise support a means for communicating, with the network entity, a control message indicating at least the first configuration.

In some examples, to support communicating the control message, the request transmission component 1050 may be configured as or otherwise support a means for transmitting, to the network entity, a request indicating at least the first configuration. In some examples, to support communicating the control message, the response reception component 1055 may be configured as or otherwise support a means for receiving, from the network entity by the first radio that is operating in the first power state, a response to the request, the response indicating approval to use at least the first configuration.

In some examples, the control signaling requests that the UE indicate one or more desired configurations for the WUR.

In some examples, to support communicating the control message, the signal multiplexing component 1060 may be configured as or otherwise support a means for transmitting a signal that multiplexes the control message with a first message associated with the UE.

In some examples, the first message includes a feedback message, a scheduling request, a buffer status report, a random access channel message, a channel state information message, RRC signaling, a medium access control control element, a UE assistance information message, a power headroom report, or any combination thereof.

In some examples, to support communicating the control message, the feedback transmission component 1065 may be configured as or otherwise support a means for communicating the control message via one or more time-frequency resources that are scheduled for feedback.

In some examples, the control message reception component 1080 may be configured as or otherwise support a means for receiving, from the network entity via a physical downlink control channel, a physical downlink control channel skipping message scheduling transmission of the control message via a physical downlink shared channel and indicating to skip monitoring of one or more control channel occasions, where the one or more time-frequency resources include a feedback resource for the physical downlink shared channel associated with the physical downlink control channel skipping message.

In some examples, the burst indication reception component 1085 may be configured as or otherwise support a means for receiving, from the network entity, an end of a burst indication associated with transmission of the control message via a physical downlink shared channel, where the one or more time-frequency resources include a feedback resource associated with the end of the burst indication.

In some examples, to support communicating the control message, the scheduling request transmission component 1070 may be configured as or otherwise support a means for communicating the control message that is a scheduling request, the scheduling request triggered in response to receiving the control signaling.

In some examples, the scheduling request includes a logical channel identifier or logical channel group identifier associated with the first configuration.

In some examples, to support communicating the control message, the resource indication reception component 1075 may be configured as or otherwise support a means for receiving, from the network entity, an indication of one or more time-frequency resources that are allocated for communicating the control message via a physical uplink control channel, where the indication is received via a layer 1 message, a layer 2 message, a layer 3 message, a physical downlink control channel skipping message, a burst control signal, or any combination thereof.

In some examples, to support communicating the control message, the control message communication component 1035 may be configured as or otherwise support a means for communicating the control message including an indication of one of a first time duration associated with the first radio transitioning from the second power state to the first power state after receiving the wake-up signal, or a second time duration associated with the first radio transitioning from the first power state to the second power state and the UE starting monitoring for the wake-up signaling by the WUR, or both.

In some examples, to support communicating the control message, the control message communication component 1035 may be configured as or otherwise support a means for communicating the control message including an indication of a desired configuration of the at least one configuration or a type of the wake-up signaling.

In some examples, the first radio transitions to the second power state in response to communicating the control message.

In some examples, the wake up signal indicates the first configuration.

In some examples, the at least one configuration is based on a preferred configuration of one or more other UEs, a class of the WUR, or both.

In some examples, the guard band indication transmission component 1040 may be configured as or otherwise support a means for transmitting, to the network entity by the first radio or by the WUR, an indication of a size of a guard band for the wake-up signal, where receiving the wake-up signal is based on transmitting the indication.

In some examples, to support transmitting the indication, the guard band indication transmission component 1040 may be configured as or otherwise support a means for transmitting the indication via one or more time-frequency resources that are scheduled for uplink transmission, RRC signaling, a medium access control control element, a UE assistance information message, a feedback message, a scheduling request, a buffer status report, a random access channel message, or any combination thereof.

In some examples, the guard band indication reception component 1045 may be configured as or otherwise support a means for receiving, from the network entity, an indication of a size of a guard band for the wake-up signal, the size of the guard band based on a class of the WUR, a preferred guard band size of one or more other UEs, or both, where receiving the wake-up signal is based on receiving the indication.

In some examples, each configuration of the at least one configuration indicates a waveform of the wake-up signaling, a modulation and coding scheme of the wake-up signaling, a coding type of the wake-up signaling, a coding rate of the wake-up signaling, a periodicity of the wake-up signaling, a quantity of time-frequency resources associated with the wake-up signaling, a guard band associated with the wake-up signaling, a frequency band of the wake-up signaling, a frequency range of the wake-up signaling, one or more component carriers of the wake-up signaling, one or more bandwidth parts of the wake-up signaling, or any combination thereof.

In some cases, the high power reception component 1025, the low power reception component 1030, the control message communication component 1035, the guard band indication transmission component 1040, the guard band indication reception component 1045, the request transmission component 1050, the response reception component 1055, the signal multiplexing component 1060, the feedback transmission component 1065, the scheduling request transmission component 1070, the resource indication reception component 1075, the control message reception component 1080, and the burst indication reception component 1085 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the high power reception component 1025, the low power reception component 1030, the control message communication component 1035, the guard band indication transmission component 1040, the guard band indication reception component 1045, the request transmission component 1050, the response reception component 1055, the signal multiplexing component 1060, the feedback transmission component 1065, the scheduling request transmission component 1070, the resource indication reception component 1075, the control message reception component 1080, and the burst indication reception component 1085 discussed herein.

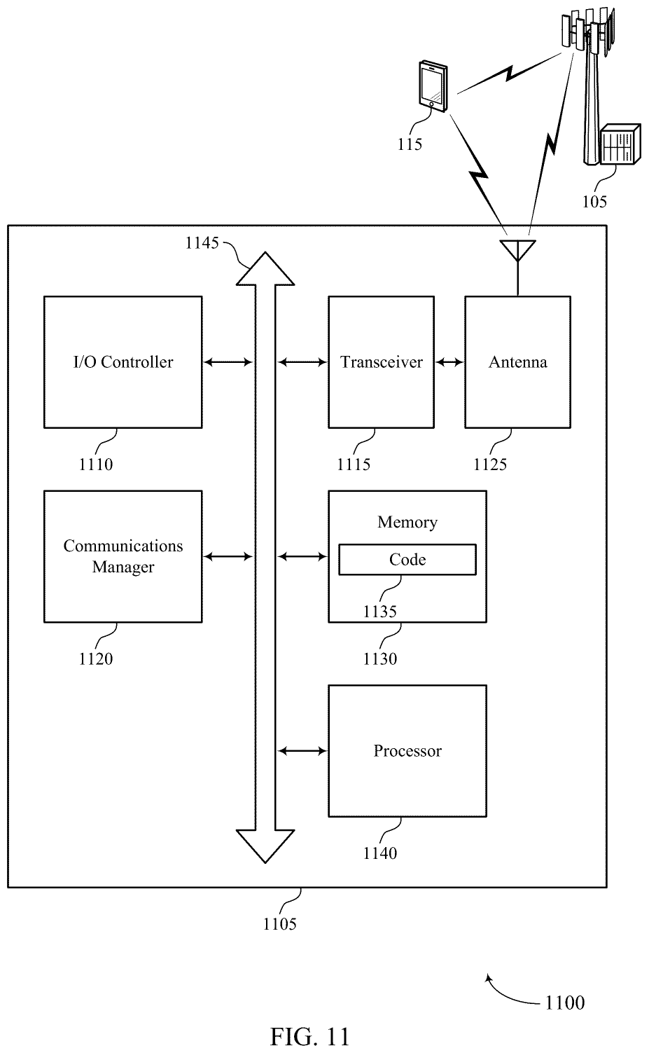

FIG. 11 illustrates a diagram of a system 1100 including a device 1105 that supports WUR desired configuration based on UE indication in accordance with one or more aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting WUR desired configuration based on UE indication). For example, the device 1105 or a component of the device 1105 may include a processor 1140 and memory 1130 coupled with or to the processor 1140, the processor 1140 and memory 1130 configured to perform various functions described herein.

The communications manager 1120 may support wireless communication at a UE in accordance with examples as disclosed herein. For example, the communications manager 1120 may be configured as or otherwise support a means for receiving, by a first radio of the UE that is operating in a first power state, control signaling indicating at least one configuration for a WUR of the UE for monitoring for wake-up signaling from a network entity, the first radio cycling between the first power state and a second power state that uses less power than the first power state. The communications manager 1120 may be configured as or otherwise support a means for receiving, by the WUR of the UE when the first radio is operating in the second power state, a wake up signal in accordance with a first configuration of the at least one configuration, the wake up signal indicating to transition the first radio from the second power state to the first power state. The communications manager 1120 may be configured as or otherwise support a means for monitoring, by the first radio of the UE that is operating in the first power state, for a message in response to WUR of the UE receiving the wake up signal.

By including or configuring the communications manager 1120 in accordance with examples as described herein, the device 1105 may support techniques for reduced power consumption by selecting a WUR configuration based on a UE indication.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of WUR desired configuration based on UE indication as described herein, or the processor 1140 and the memory 1130 may be otherwise configured to perform or support such operations.

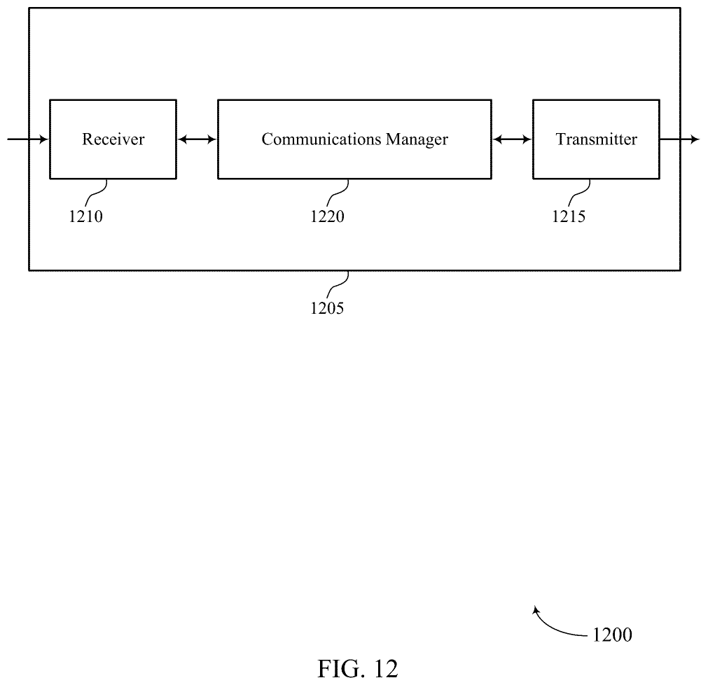

FIG. 12 illustrates a block diagram 1200 of a device 1205 that supports WUR desired configuration based on UE indication in accordance with one or more aspects of the present disclosure. The device 1205 may be an example of aspects of a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations thereof or various components thereof may be examples of means for performing various aspects of WUR desired configuration based on UE indication as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1220, the receiver 1210, the transmitter 1215, or various combinations or components thereof may be implemented in code (e.g., as communications management software or firmware) executed by a processor. If implemented in code executed by a processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network entity in accordance with examples as disclosed herein. For example, the communications manager 1220 may be configured as or otherwise support a means for transmitting, to a first radio of a UE that is operating a first power state, control signaling indicating at least one configuration for a WUR of the UE for monitoring for wake-up signaling from the network entity, the first radio of the UE cycling between the first power state and a second power state that uses less power than the first power state. The communications manager 1220 may be configured as or otherwise support a means for transmitting, to the WUR of the UE when the first radio of the UE is operating in the second power state, a wake up signal in accordance with a first configuration of the at least one configuration, the wake up signal indicating to transition the first radio from the second power state to the first power state. The communications manager 1220 may be configured as or otherwise support a means for communicating a message with the UE in response to transmitting the wake up signal in accordance with the first configuration.

By including or configuring the communications manager 1220 in accordance with examples as described herein, the device 1205 (e.g., a processor controlling or otherwise coupled with the receiver 1210, the transmitter 1215, the communications manager 1220, or a combination thereof) may support techniques for reduced power consumption by selecting a WUR configuration based on a UE indication.

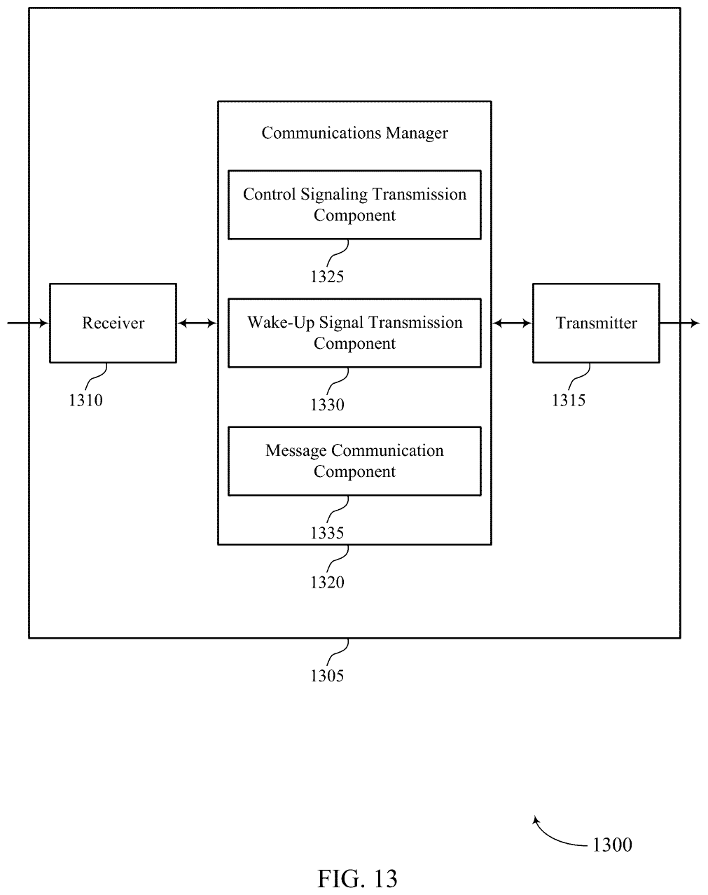

FIG. 13 illustrates a block diagram 1300 of a device 1305 that supports WUR desired configuration based on UE indication in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of WUR desired configuration based on UE indication as described herein. For example, the communications manager 1320 may include a control signaling transmission component 1325, a wake-up signal transmission component 1330, a message communication component 1335, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communication at a network entity in accordance with examples as disclosed herein. The control signaling transmission component 1325 may be configured as or otherwise support a means for transmitting, to a first radio of a UE that is operating a first power state, control signaling indicating at least one configuration for a WUR of the UE for monitoring for wake-up signaling from the network entity, the first radio of the UE cycling between the first power state and a second power state that uses less power than the first power state. The wake-up signal transmission component 1330 may be configured as or otherwise support a means for transmitting, to the WUR of the UE when the first radio of the UE is operating in the second power state, a wake up signal in accordance with a first configuration of the at least one configuration, the wake up signal indicating to transition the first radio from the second power state to the first power state. The message communication component 1335 may be configured as or otherwise support a means for communicating a message with the UE in response to transmitting the wake up signal in accordance with the first configuration.

In some cases, the control signaling transmission component 1325, the wake-up signal transmission component 1330, and the message communication component 1335 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the control signaling transmission component 1325, the wake-up signal transmission component 1330, and the message communication component 1335 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

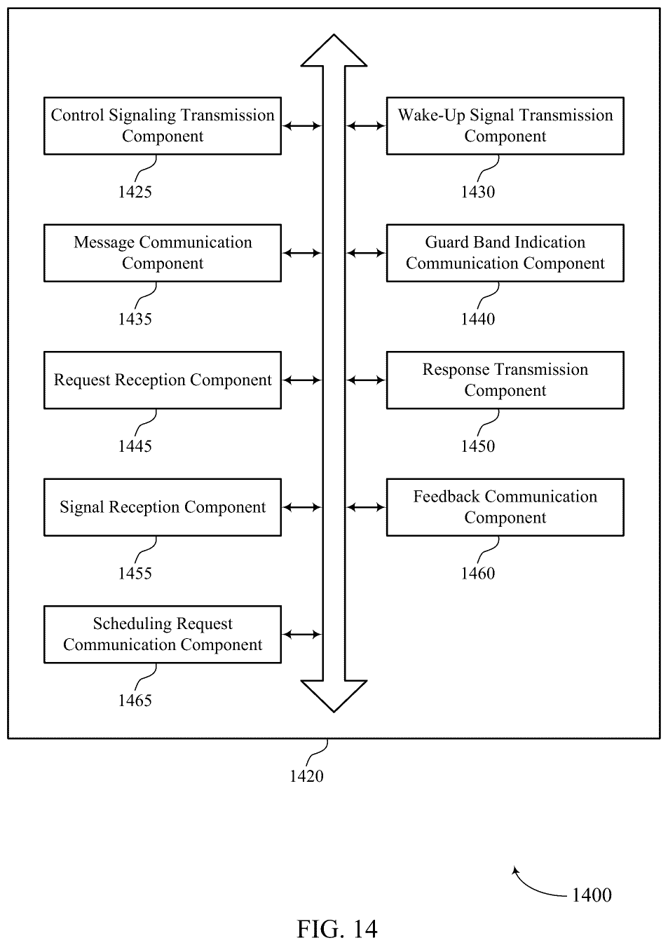

FIG. 14 illustrates a block diagram 1400 of a communications manager 1420 that supports WUR desired configuration based on UE indication in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of WUR desired configuration based on UE indication as described herein. For example, the communications manager 1420 may include a control signaling transmission component 1425, a wake-up signal transmission component 1430, a message communication component 1435, a guard band indication communication component 1440, a request reception component 1445, a response transmission component 1450, a signal reception component 1455, a feedback communication component 1460, a scheduling request communication component 1465, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communication at a network entity in accordance with examples as disclosed herein. The control signaling transmission component 1425 may be configured as or otherwise support a means for transmitting, to a first radio of a UE that is operating a first power state, control signaling indicating at least one configuration for a WUR of the UE for monitoring for wake-up signaling from the network entity, the first radio of the UE cycling between the first power state and a second power state that uses less power than the first power state. The wake-up signal transmission component 1430 may be configured as or otherwise support a means for transmitting, to the WUR of the UE when the first radio of the UE is operating in the second power state, a wake up signal in accordance with a first configuration of the at least one configuration, the wake up signal indicating to transition the first radio from the second power state to the first power state. The message communication component 1435 may be configured as or otherwise support a means for communicating a message with the UE in response to transmitting the wake up signal in accordance with the first configuration.

In some examples, the control signaling transmission component 1425 may be configured as or otherwise support a means for communicating, with the UE, a control message indicating at least the first configuration.

In some examples, to support communicating the control message, the request reception component 1445 may be configured as or otherwise support a means for receiving, from the UE, a request indicating at least the first configuration. In some examples, to support communicating the control message, the response transmission component 1450 may be configured as or otherwise support a means for transmitting, to the first radio of the UE that is operating in the first power state, a response to the request, the response indicating approval to use at least the first configuration.

In some examples, the control signaling requests that the UE indicate one or more desired configurations for the WUR.

In some examples, to support communicating the control message, the signal reception component 1455 may be configured as or otherwise support a means for receiving a signal that multiplexes the control message with a first message associated with the UE.

In some examples, to support communicating the control message, the feedback communication component 1460 may be configured as or otherwise support a means for communicating the control message via one or more time-frequency resources that are scheduled for feedback associated with the control signaling.

In some examples, to support communicating the control message, the scheduling request communication component 1465 may be configured as or otherwise support a means for communicating the control message that is a scheduling request, the scheduling request triggered in response to transmitting the control signaling.

In some examples, the wake up signal indicates the first configuration.

In some examples, the guard band indication communication component 1440 may be configured as or otherwise support a means for receiving, from the first radio or from the WUR of the UE, an indication of a size of a guard band for the wake-up signal, where transmitting the wake-up signal is based on receiving the indication.

In some examples, the guard band indication communication component 1440 may be configured as or otherwise support a means for transmitting, to the UE, an indication of a size of a guard band for the wake-up signal, the size of the guard band based on a class of the WUR of the UE, a preferred guard band size of one or more other UEs, or both, where transmitting the wake-up signal is based on transmitting the indication.

In some cases, the control signaling transmission component 1425, the wake-up signal transmission component 1430, the message communication component 1435, the guard band indication communication component 1440, the request reception component 1445, the response transmission component 1450, the signal reception component 1455, the feedback communication component 1460, and the scheduling request communication component 1465 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the control signaling transmission component 1425, the wake-up signal transmission component 1430, the message communication component 1435, the guard band indication communication component 1440, the request reception component 1445, the response transmission component 1450, the signal reception component 1455, the feedback communication component 1460, and the scheduling request communication component 1465 discussed herein.

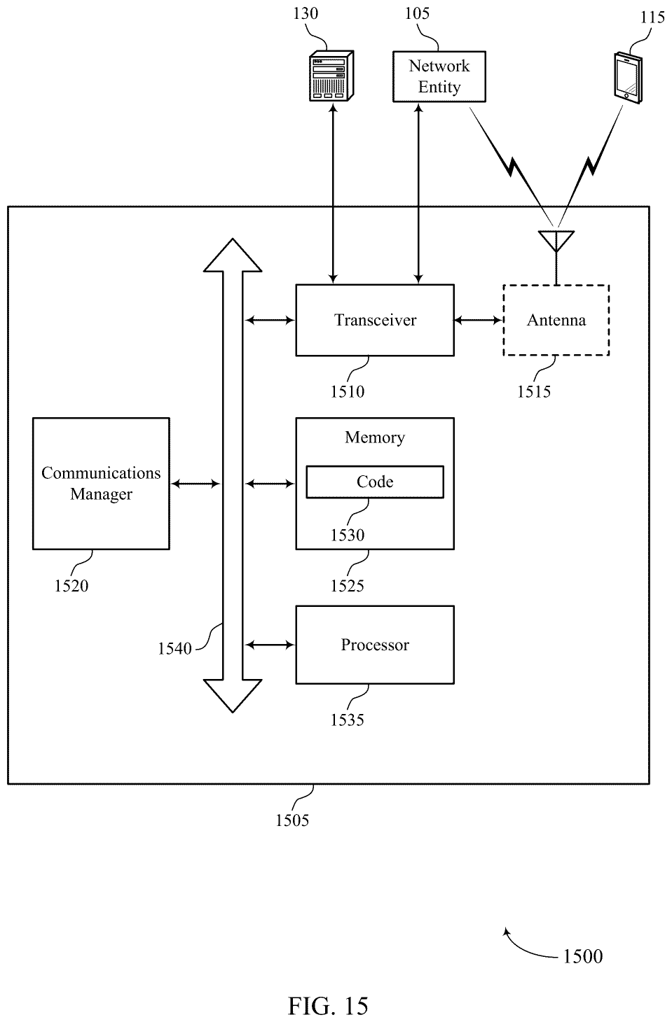

FIG. 15 illustrates a diagram of a system 1500 including a device 1505 that supports WUR desired configuration based on UE indication in accordance with one or more aspects of the present disclosure. The device 1505 may be an example of or include the components of a device 1205, a device 1305, or a network entity 105 as described herein. The device 1505 may communicate with one or more network entities 105, one or more UEs 115, or any combination thereof, which may include communications over one or more wired interfaces, over one or more wireless interfaces, or any combination thereof. The device 1505 may include components that support outputting and obtaining communications, such as a communications manager 1520, a transceiver 1510, an antenna 1515, a memory 1525, code 1530, and a processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or memory components (for example, the processor 1535, or the memory 1525, or both), may be included in a chip or chip assembly that is installed in the device 1505. In some examples, the transceiver may be operable to support communications via one or more communications links (e.g., a communication link 125, a backhaul communication link 120, a midhaul communication link 162, a fronthaul communication link 168).

The memory 1525 may include RAM and ROM. The memory 1525 may store computer-readable, computer-executable code 1530 including instructions that, when executed by the processor 1535, cause the device 1505 to perform various functions described herein. The code 1530 may be stored in a non-transitory computer-readable medium such as system memory or another type of memory. In some cases, the code 1530 may not be directly executable by the processor 1535 but may cause a computer (e.g., when compiled and executed) to perform functions described herein. In some cases, the memory 1525 may contain, among other things, a BIOS which may control basic hardware or software operation such as the interaction with peripheral components or devices.

The processor 1535 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1535 may be configured to operate a memory array using a memory controller. In some other cases, a memory controller may be integrated into the processor 1535. The processor 1535 may be configured to execute computer-readable instructions stored in a memory (e.g., the memory 1525) to cause the device 1505 to perform various functions (e.g., functions or tasks supporting WUR desired configuration based on UE indication). For example, the device 1505 or a component of the device 1505 may include a processor 1535 and memory 1525 coupled with the processor 1535, the processor 1535 and memory 1525 configured to perform various functions described herein. The processor 1535 may be an example of a cloud-computing platform (e.g., one or more physical nodes and supporting software such as operating systems, virtual machines, or container instances) that may host the functions (e.g., by executing code 1530) to perform the functions of the device 1505. The processor 1535 may be any one or more suitable processors capable of executing scripts or instructions of one or more software programs stored in the device 1505 (such as within the memory 1525). In some implementations, the processor 1535 may be a component of a processing system. A processing system may generally refer to a system or series of machines or components that receives inputs and processes the inputs to produce a set of outputs (which may be passed to other systems or components of, for example, the device 1505). For example, a processing system of the device 1505 may refer to a system including the various other components or subcomponents of the device 1505, such as the processor 1535, or the transceiver 1510, or the communications manager 1520, or other components or combinations of components of the device 1505. The processing system of the device 1505 may interface with other components of the device 1505, and may process information received from other components (such as inputs or signals) or output information to other components. For example, a chip or modem of the device 1505 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1505 may transmit information output from the chip or modem. Additionally, or alternatively, in some implementations, the one or more interfaces may refer to an interface between the processing system of the chip or modem and a receiver, such that the device 1505 may obtain information or signal inputs, and the information may be passed to the processing system. A person having ordinary skill in the art will readily recognize that a first interface also may obtain information or signal inputs, and a second interface also may output information or signal outputs.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the memory 1525, the code 1530, and the processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with other network entities 105, and may include a controller or scheduler for controlling communications with UEs 115 in cooperation with other network entities 105. In some examples, the communications manager 1520 may support an X2 interface within an LTE/LTE-A wireless communications network technology to provide communication between network entities 105.

The communications manager 1520 may support wireless communication at a network entity in accordance with examples as disclosed herein. For example, the communications manager 1520 may be configured as or otherwise support a means for transmitting, to a first radio of a UE that is operating a first power state, control signaling indicating at least one configuration for a WUR of the UE for monitoring for wake-up signaling from the network entity, the first radio of the UE cycling between the first power state and a second power state that uses less power than the first power state. The communications manager 1520 may be configured as or otherwise support a means for transmitting, to the WUR of the UE when the first radio of the UE is operating in the second power state, a wake up signal in accordance with a first configuration of the at least one configuration, the wake up signal indicating to transition the first radio from the second power state to the first power state. The communications manager 1520 may be configured as or otherwise support a means for communicating a message with the UE in response to transmitting the wake up signal in accordance with the first configuration.

By including or configuring the communications manager 1520 in accordance with examples as described herein, the device 1505 may support techniques for reduced power consumption by selecting a WUR configuration based on a UE indication.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, the processor 1535, the memory 1525, the code 1530, or any combination thereof. For example, the code 1530 may include instructions executable by the processor 1535 to cause the device 1505 to perform various aspects of WUR desired configuration based on UE indication as described herein, or the processor 1535 and the memory 1525 may be otherwise configured to perform or support such operations.

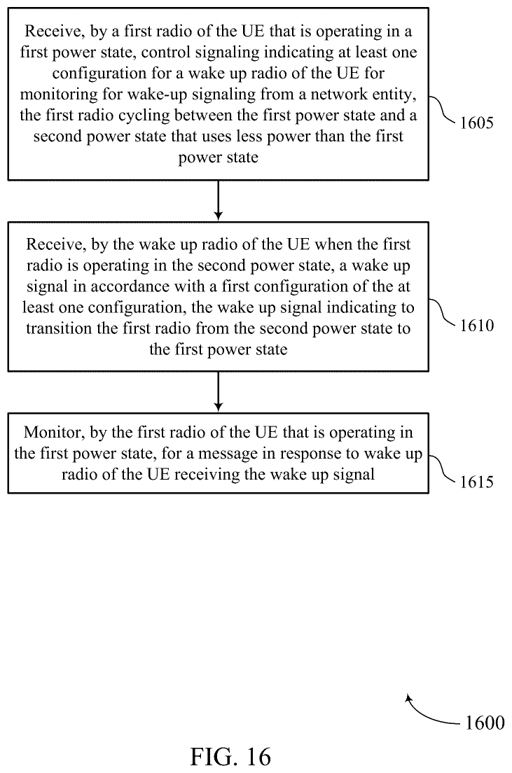

FIG. 16 illustrates a flowchart showing a method 1600 that supports WUR desired configuration based on UE indication in accordance with one or more aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include receiving, by a first radio of the UE that is operating in a first power state, control signaling indicating at least one configuration for a WUR of the UE for monitoring for wake-up signaling from a network entity, the first radio cycling between the first power state and a second power state that uses less power than the first power state. The operations of 1605 may be performed in accordance with examples as disclosed herein. In some examples, aspects of the operations of 1605 may be performed by a high power reception component 1025 as described with reference to FIG. 10.

At 1610, the method may include receiving, by the WUR of the UE when the first radio is operating in the second power state, a wake up signal in accordance with a first configuration of the at least one configuration, the wake up signal indicating to transition the first radio from the second power state to the first power state. The operations of 1610 may be performed in accordance with examples as disclosed herein. In some examples, aspects of the operations of 1610 may be performed by a low power reception component 1030 as described with reference to FIG. 10.

At 1615, the method may include monitoring, by the first radio of the UE that is operating in the first power state, for a message in response to WUR of the UE receiving the wake up signal. The operations of 1615 may be performed in accordance with examples as disclosed herein. In some examples, aspects of the operations of 1615 may be performed by a high power reception component 1025 as described with reference to FIG. 10.

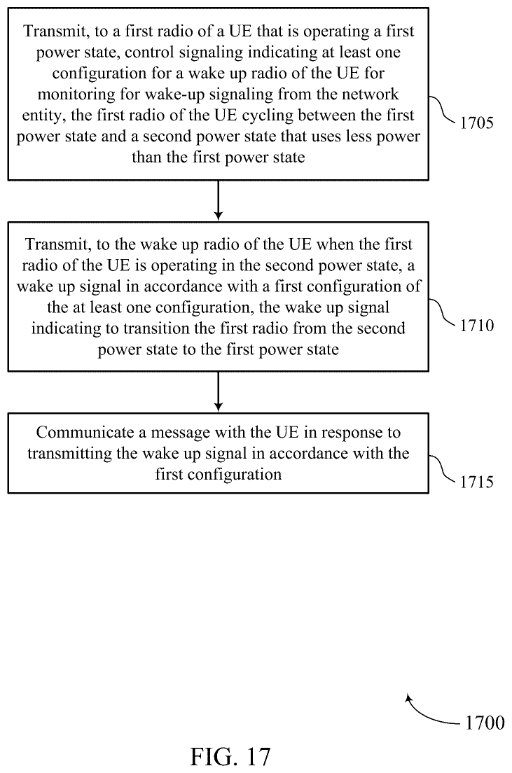

FIG. 17 illustrates a flowchart showing a method 1700 that supports WUR desired configuration based on UE indication in accordance with one or more aspects of the present disclosure. The operations of the method 1700 may be implemented by a network entity or its components as described herein. For example, the operations of the method 1700 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1705, the method may include transmitting, to a first radio of a UE that is operating a first power state, control signaling indicating at least one configuration for a WUR of the UE for monitoring for wake-up signaling from the network entity, the first radio of the UE cycling between the first power state and a second power state that uses less power than the first power state. The operations of 1705 may be performed in accordance with examples as disclosed herein. In some examples, aspects of the operations of 1705 may be performed by a control signaling transmission component 1425 as described with reference to FIG. 14.

At 1710, the method may include transmitting, to the WUR of the UE when the first radio of the UE is operating in the second power state, a wake up signal in accordance with a first configuration of the at least one configuration, the wake up signal indicating to transition the first radio from the second power state to the first power state. The operations of 1710 may be performed in accordance with examples as disclosed herein. In some examples, aspects of the operations of 1710 may be performed by a wake-up signal transmission component 1430 as described with reference to FIG. 14.

At 1715, the method may include communicating a message with the UE in response to transmitting the wake up signal in accordance with the first configuration. The operations of 1715 may be performed in accordance with examples as disclosed herein. In some examples, aspects of the operations of 1715 may be performed by a message communication component 1435 as described with reference to FIG. 14.

The following provides an overview of aspects of the present disclosure:
Aspect 1: A method for wireless communication at a UE, comprising: receiving, by a first radio of the UE that is operating in a first power state, control signaling indicating at least one configuration for a WUR of the UE for monitoring for wake-up signaling from a network entity, the first radio cycling between the first power state and a second power state that uses less power than the first power state; and receiving, by the WUR of the UE when the first radio is operating in the second power state, a wake up signal in accordance with a first configuration of the at least one configuration, the wake up signal indicating to transition the first radio from the second power state to the first power state; and monitoring, by the first radio of the UE that is operating in the first power state, for a message in response to WUR of the UE receiving the wake up signal.
Aspect 2: The method of aspect 1, further comprising: communicating, with the network entity, a control message indicating at least the first configuration.
Aspect 3: The method of aspect 2, wherein communicating the control message further comprises: transmitting, to the network entity, a request indicating at least the first configuration; and receiving, from the network entity by the first radio that is operating in the first power state, a response to the request, the response indicating approval to use at least the first configuration.
Aspect 4: The method of aspect 3, wherein the control signaling requests that the UE indicate one or more desired configurations for the WUR.
Aspect 5: The method of aspect 4, wherein a first configuration of the one or more desired configurations is for operating the WUR in a RRC idle state, a second configuration of the one or more desired configurations is for operating the WUR in a RRC inactive state, a third configuration of the one or more desired configurations is for operating the WUR in a RRC inactive state, or any combination thereof.
Aspect 6: The method of any of aspects 2 through 5, wherein communicating the control message further comprises: transmitting a signal that multiplexes the control message with a first message associated with the UE.
Aspect 7: The method of aspect 6, wherein the first message comprises a feedback message, a scheduling request, a buffer status report, a random access channel message, a channel state information message, RRC signaling, a medium access control control element, a UE assistance information message, a power headroom report, a small data transmission, or any combination thereof.
Aspect 8: The method of any of aspects 2 through 7, wherein communicating the control message further comprises: communicating the control message via one or more time-frequency resources that are scheduled for feedback.
Aspect 9: The method of aspect 8, further comprising: receiving, from the network entity via a physical downlink control channel, a physical downlink control channel skipping message scheduling transmission of the message via a physical downlink shared channel and indicating to skip monitoring of one or more control channel occasions, wherein the one or more time-frequency resources comprise a feedback resource for the physical downlink shared channel associated with the physical downlink control channel skipping message.
Aspect 10: The method of aspect 8, further comprising: receiving, from the network entity, an end of a burst indication associated with transmission of the control message via a physical downlink shared channel, wherein the one or more time-frequency resources comprise a feedback resource associated with the end of the burst indication.
Aspect 11: The method of any of aspects 2 through 10, wherein communicating the control message further comprises: communicating the control message that is a scheduling request, the scheduling request triggered in response to receiving the control signaling.
Aspect 12: The method of aspect 11, wherein the scheduling request comprises a logical channel identifier or logical channel group identifier associated with the first configuration.
Aspect 13: The method of any of aspects 2 through 12, wherein communicating the control message further comprises: receiving, from the network entity, an indication of one or more time-frequency resources that are allocated for communicating the control message via a physical uplink control channel, wherein the indication is received via a layer 1 message, a layer 2 message, a layer 3 message, a physical downlink control channel skipping message, a burst control signal, or any combination thereof.
Aspect 14: The method of any of aspects 2 through 13, wherein communicating the control message further comprises: communicating the control message comprising an indication of one of a first time duration associated with the first radio transitioning from the second power state to the first power state after receiving the wake-up signal, or a second time duration associated with the first radio transitioning from the first power state to the second power state and the UE starting monitoring for the wake-up signaling by the WUR, or both.
Aspect 15: The method of any of aspects 2 through 14, wherein communicating the control message further comprises: communicating the control message comprising an indication of a desired configuration of the at least one configuration or a type of the wake-up signaling.
Aspect 16: The method of any of aspects 2 through 15, wherein the first radio transitions to the second power state in response to communicating the control message.
Aspect 17: The method of any of aspects 1 through 16, wherein the wake up signal indicates the first configuration.
Aspect 18: The method of any of aspects 1 through 17, wherein the at least one configuration is based at least in part on a preferred configuration of one or more other UEs, a class of the WUR, or both.
Aspect 19: The method of any of aspects 1 through 18, further comprising: transmitting, to the network entity by the first radio or by the WUR, an indication of a size of a guard band for the wake-up signal, wherein receiving the wake-up signal is based at least in part on transmitting the indication.
Aspect 20: The method of aspect 19, wherein transmitting the indication further comprises: transmitting the indication via one or more time-frequency resources that are scheduled for uplink transmission, RRC signaling, a medium access control control element, a UE assistance information message, a feedback message, a scheduling request, a buffer status report, a random access channel message, or any combination thereof.
Aspect 21: The method of any of aspects 1 through 20, further comprising: receiving, from the network entity, an indication of a size of a guard band for the wake-up signal, the size of the guard band based at least in part on a class of the WUR, a preferred guard band size of one or more other UEs, or both, wherein receiving the wake-up signal is based at least in part on receiving the indication.
Aspect 22: The method of any of aspects 1 through 21, wherein each configuration of the at least one configuration indicates a waveform of the wake-up signaling, a modulation and coding scheme of the wake-up signaling, a coding type of the wake-up signaling, a coding rate of the wake-up signaling, a periodicity of the wake-up signaling, a quantity of time-frequency resources associated with the wake-up signaling, a guard band associated with the wake-up signaling, a frequency band of the wake-up signaling, a frequency range of the wake-up signaling, one or more component carriers of the wake-up signaling, one or more bandwidth parts of the wake-up signaling, or any combination thereof.
Aspect 23: The method of any of aspects 1 through 22, wherein the WUR is an ambient internet of things radio.
Aspect 24: The method of any of aspects 1 through 23, further comprising: operating the WUR according to a discontinuous reception cycle.
Aspect 25: The method of aspect 24, wherein monitoring for the message comprises: monitoring for the message during an active time of the discontinuous reception cycle.
Aspect 26: The method of aspect 24, wherein monitoring for the message comprises: monitoring one or more resource sets during an active time of the discontinuous reception cycle, each resource set of the one or more resource sets comprising at least one resource for receiving wake-up signaling.
Aspect 27: The method of aspect 24, wherein monitoring for the message comprises: monitoring for the message during an active time of a first discontinuous reception cycle, wherein the message comprises a first type of message; or monitoring for the message during an active time of a second discontinuous reception cycle, wherein the message comprises a second type of message, wherein the first type of message comprises a wake-up signal, control information, or both and the second type of message comprises a reference signal, a synchronization signal, or both.
Aspect 28: A method for wireless communication at a network entity, comprising: transmitting, to a first radio of a UE that is operating a first power state, control signaling indicating at least one configuration for a WUR of the UE for monitoring for wake-up signaling from the network entity, the first radio of the UE cycling between the first power state and a second power state that uses less power than the first power state; transmitting, to the WUR of the UE when the first radio of the UE is operating in the second power state, a wake up signal in accordance with a first configuration of the at least one configuration, the wake up signal indicating to transition the first radio from the second power state to the first power state; and communicating a message with the UE in response to transmitting the wake up signal in accordance with the first configuration.
Aspect 29: The method of aspect 28, further comprising: communicating, with the UE, a control message indicating at least the first configuration.
Aspect 30: The method of aspect 29, wherein communicating the control message further comprises: receiving, from the UE, a request indicating at least the first configuration; and transmitting, to the first radio of the UE that is operating in the first power state, a response to the request, the response indicating approval to use at least the first configuration.
Aspect 31: The method of aspect 30, wherein the control signaling requests that the UE indicate one or more desired configurations for the WUR.
Aspect 32: The method of any of aspects 29 through 31, wherein communicating the control message further comprises: receiving a signal that multiplexes the control message with a first message associated with the UE.
Aspect 33: The method of any of aspects 29 through 32, wherein communicating the control message further comprises: communicating the control message via one or more time-frequency resources that are scheduled for feedback associated with the control signaling.
Aspect 34: The method of any of aspects 29 through 33, wherein communicating the control message further comprises: communicating the control message that is a scheduling request, the scheduling request triggered in response to transmitting the control signaling.
Aspect 35: The method of any of aspects 28 through 34, wherein the wake up signal indicates the first configuration.
Aspect 36: The method of any of aspects 28 through 35, further comprising: receiving, from the first radio or from the WUR of the UE, an indication of a size of a guard band for the wake-up signal, wherein transmitting the wake-up signal is based at least in part on receiving the indication.
Aspect 37: The method of any of aspects 28 through 36, further comprising: transmitting, to the UE, an indication of a size of a guard band for the wake-up signal, the size of the guard band based at least in part on a class of the WUR of the UE, a preferred guard band size of one or more other UEs, or both, wherein transmitting the wake-up signal is based at least in part on transmitting the indication.
Aspect 38: An apparatus for wireless communication at a UE, comprising a processor; memory coupled with the processor; and instructions stored in the memory and executable by the processor to cause the apparatus to perform a method of any of aspects 1 through 27.
Aspect 39: An apparatus for wireless communication at a UE, comprising at least one means for performing a method of any of aspects 1 through 27.
Aspect 40: A non-transitory computer-readable medium storing code for wireless communication at a UE, the code comprising instructions executable by a processor to perform a method of any of aspects 1 through 27.
Aspect 41: An apparatus for wireless communication at a network entity, comprising a processor; memory coupled with the processor; and instructions stored in the memory and executable by the processor to cause the apparatus to perform a method of any of aspects 28 through 37.
Aspect 42: An apparatus for wireless communication at a network entity, comprising at least one means for performing a method of any of aspects 28 through 37.
Aspect 43: A non-transitory computer-readable medium storing code for wireless communication at a network entity, the code comprising instructions executable by a processor to perform a method of any of aspects 28 through 37.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a user equipment (UE), comprising:
a processor;
memory coupled with the processor; and
instructions stored in the memory and executable by the processor to cause the apparatus to:
receive, by a first radio of the UE that is operating in a first power state, control signaling indicating at least one configuration for a wake-up radio of the UE for monitoring for wake-up signaling from a network entity, the first radio cycling between the first power state and a second power state that uses less power than the first power state;
receive, by the wake-up radio of the UE when the first radio is operating in the second power state, a wake-up signal in accordance with a first configuration of the at least one configuration, the wake-up signal indicating to transition the first radio from the second power state to the first power state; and
monitor, by the first radio of the UE that is operating in the first power state, for a message in response to wake-up radio of the UE receiving the wake-up signal.

2. The apparatus of claim 1, wherein the instructions are further executable by the processor to cause the apparatus to:
communicate, with the network entity, a control message indicating at least the first configuration.

3. The apparatus of claim 2, wherein the instructions to communicate the control message are further executable by the processor to cause the apparatus to:
transmit, to the network entity, a request indicating at least the first configuration; and
receive, from the network entity by the first radio that is operating in the first power state, a response to the request, the response indicating approval to use at least the first configuration.

4. The apparatus of claim 3, wherein the control signaling requests that
the UE indicate one or more desired configurations for the wake-up radio.

5. The apparatus of claim 4, wherein a first configuration of the one or more desired configurations is for operating the wake-up radio in a radio resource control idle state, a second configuration of the one or more desired configurations is for operating the wake-up radio in a radio resource control inactive state, a third configuration of the one or more desired configurations is for operating the wake-up radio in a radio resource control connected state, or any combination thereof.

6. The apparatus of claim 2, wherein the instructions to communicate the control message are further executable by the processor to cause the apparatus to:
transmit a signal that multiplexes the control message with a first message associated with the UE.

7. The apparatus of claim 6, wherein the first message comprises:
a feedback message, a scheduling request, a buffer status report, a random access channel message, a channel state information message, radio resource control signaling, a medium access control control element, a UE assistance information message, a power headroom report, a small data transmission, or any combination thereof.

8. The apparatus of claim 2, wherein the instructions to communicate the control message are further executable by the processor to cause the apparatus to:
communicate the control message via one or more time-frequency resources that are scheduled for feedback.

9. The apparatus of claim 8, wherein the instructions are further executable by the processor to cause the apparatus to:
receive, from the network entity via a physical downlink control channel, a physical downlink control channel skipping message scheduling transmission of the message via a physical downlink shared channel and indicating to skip monitoring of one or more control channel occasions, wherein the one or more time-frequency resources comprise a feedback resource for the physical downlink shared channel associated with the physical downlink control channel skipping message.

10. The apparatus of claim 8, wherein the instructions are further executable by the processor to cause the apparatus to:
receive, from the network entity, an end of a burst indication associated with transmission of the message via a physical downlink shared channel, wherein the one or more time-frequency resources comprise a feedback resource associated with the end of the burst indication.

11. The apparatus of claim 2, wherein the instructions to communicate the control message are further executable by the processor to cause the apparatus to:
communicate the control message that is a scheduling request, the scheduling request triggered in response to receiving the control signaling.

12. The apparatus of claim 11, wherein the scheduling request comprises a logical channel identifier or logical channel group identifier associated with the first configuration.

13. The apparatus of claim 2, wherein the instructions to communicate the control message are further executable by the processor to cause the apparatus to:
receive, from the network entity, an indication of one or more time-frequency resources that are allocated for communicating the control message via a physical uplink control channel, wherein the indication is received via a layer 1 message, a layer 2 message, a layer 3 message, a physical downlink control channel skipping message, a burst control signal, or any combination thereof.

14. The apparatus of claim 2, wherein the instructions to communicate the control message are further executable by the processor to cause the apparatus to:
communicate the control message comprising an indication of one of a first time duration associated with the first radio transitioning from the second power state to the first power state after receiving the wake-up signal, or a second time duration associated with the first radio transitioning from the first power state to the second power state and the UE starting monitoring for the wake-up signaling by the wake-up radio, or both.

15. The apparatus of claim 2, wherein the instructions to communicate the control message are further executable by the processor to cause the apparatus to:
communicate the control message comprising an indication of a desired configuration of the at least one configuration or a type of the wake-up signaling.

16. The apparatus of claim 2, wherein the first radio transitions to the second power state in response to communicating the control message.

17. The apparatus of claim 1, wherein the wake-up signal indicates the first configuration.

18. The apparatus of claim 1, wherein the at least one configuration is based at least in part on a preferred configuration of one or more other UEs, a class of the wake-up radio, or both.

19. The apparatus of claim 1, wherein the instructions are further executable by the processor to cause the apparatus to:
transmit, to the network entity by the first radio or by the wake-up radio, an indication of a size of a guard band for the wake-up signal, wherein receiving the wake-up signal is based at least in part on transmitting the indication.

20. The apparatus of claim 19, wherein the instructions to transmit the indication are further executable by the processor to cause the apparatus to:
transmit the indication via one or more time-frequency resources that are scheduled for uplink transmission, radio resource control signaling, a medium access control control element, a UE assistance information message, a feedback message, a scheduling request, a buffer status report, a random access channel message, or any combination thereof.

21. The apparatus of claim 1, wherein the instructions are further executable by the processor to cause the apparatus to:
receive, from the network entity, an indication of a size of a guard band for the wake-up signal, the size of the guard band based at least in part on a class of the wake-up radio, a preferred guard band size of one or more other UEs, or both, wherein receiving the wake-up signal is based at least in part on receiving the indication.

22. The apparatus of claim 1, wherein each configuration of the at least one configuration indicates a waveform of the wake-up signaling, a modulation and coding scheme of the wake-up signaling, a coding type of the wake-up signaling, a coding rate of the wake-up signaling, a periodicity of the wake-up signaling, a quantity of time-frequency resources associated with the wake-up signaling, a guard band associated with the wake-up signaling, a frequency band of the wake-up signaling, a frequency range of the wake-up signaling, one or more component carriers of the wake-up signaling, one or more bandwidth parts of the wake-up signaling, or any combination thereof.

23. The apparatus of claim 1, wherein the wake-up radio is an ambient internet of things radio.

24. The apparatus of claim 1, wherein the instructions are further executable by the processor to cause the apparatus to:
operate the wake-up radio according to a discontinuous reception cycle.

25. The apparatus of claim 24, wherein the instructions to monitor for the message are executable by the processor to cause the apparatus to:
monitor for the message during an active time of the discontinuous reception cycle.

26. The apparatus of claim 24, wherein the instructions to monitor for the message are executable by the processor to cause the apparatus to:
monitor one or more resource sets during an active time of the discontinuous reception cycle, each resource set of the one or more resource sets comprising at least one resource for receiving wake-up signaling.

27. The apparatus of claim 24, wherein the instructions to monitor for the message are executable by the processor to cause the apparatus to:
monitor for the message during an active time of a first discontinuous reception cycle, wherein the message comprises a first type of message; or
monitor for the message during an active time of a second discontinuous reception cycle, wherein the message comprises a second type of message, wherein the first type of message comprises a wake-up signal, control information, or both and the second type of message comprises a reference signal, a synchronization signal, or both.

28. An apparatus for wireless communication at a network entity, comprising:
a processor;
memory coupled with the processor; and
instructions stored in the memory and executable by the processor to cause the apparatus to:
transmit, to a first radio of a user equipment (UE) that is operating a first power state, control signaling indicating at least one configuration for a wake-up radio of the UE for monitoring for wake-up signaling from the network entity, the first radio of the UE cycling between the first power state and a second power state that uses less power than the first power state;
transmit, to the wake-up radio of the UE when the first radio of the UE is operating in the second power state, a wake-up signal in accordance with a first configuration of the at least one configuration, the wake-up signal indicating to transition the first radio from the second power state to the first power state; and
communicate a message with the UE in response to transmitting the wake-up signal in accordance with the first configuration.

29. A method for wireless communication at a user equipment (UE), comprising:
receiving, by a first radio of the UE that is operating in a first power state, control signaling indicating at least one configuration for a wake-up radio of the UE for monitoring for wake-up signaling from a network entity, the first radio cycling between the first power state and a second power state that uses less power than the first power state;
receiving, by the wake-up radio of the UE when the first radio is operating in the second power state, a wake-up signal in accordance with a first configuration of the at least one configuration, the wake-up signal indicating to transition the first radio from the second power state to the first power state; and
monitoring, by the first radio of the UE that is operating in the first power state, for a message in response to wake-up radio of the UE receiving the wake-up signal.

30. A method for wireless communication at a network entity, comprising:
transmitting, to a first radio of a user equipment (UE) that is operating a first power state, control signaling indicating at least one configuration for a wake-up radio of the UE for monitoring for wake-up signaling from the network entity, the first radio of the UE cycling between the first power state and a second power state that uses less power than the first power state;
transmitting, to the wake-up radio of the UE when the first radio of the UE is operating in the second power state, a wake-up signal in accordance with a first configuration of the at least one configuration, the wake-up signal indicating to transition the first radio from the second power state to the first power state; and
communicating a message with the UE in response to transmitting the wake-up signal in accordance with the first configuration.
